(19) United States
(12) Patent Application Publication
(10) Pub. No.: US 2023/0020256 A1
(43) Pub. Date: Jan. 19, 2023

(54) High-Performance Microsized Anodes and Methods of Making and Using the Same

(71) Applicant: University of Maryland, College Park, College Park, MD (US)

(72) Inventors: Chunsheng WANG, Silver Spring, MD (US); Ji CHEN, College Park, MD (US); Xiulin FAN, College Park, MD (US)

(73) Assignee: University of Maryland, College Park, College Park, MD (US)

(21) Appl. No.: 17/801,260

(22) PCT Filed: Feb. 19, 2021
(86) PCT No.: PCT/US21/18690

§ 371 Date: Aug. 21, 2022

Related U.S. Application Data
(60) Provisional application No. 62/978,637, filed on Feb. 19, 2020.

(51) Int. Cl. H01M 4/36; H01M 10/0568; H01M 10/0525; H01M 4/134

(52) U.S. Cl. CPC H01M 4/366; H01M 10/0568; H01M 10/0525; H01M 4/134; H01M 2004/021

(57) ABSTRACT

The present invention provides an anode composition comprising (i) a core material (10) comprising a microparticle; (ii) a lithium alloy of said microparticle (14) on a surface of said core material (10); and (iii) a solid electrolyte interface (“SEI”) comprising (a) a LiF and (b) a polymer. The microparticle comprises Si, Al, Bi, Sn, Zn, or a mixture thereof. The present invention also relates to an electrolyte comprising a high lithium fluoride salt concentration in a low reduction potential solvent that is used produce the solid electrolyte interface comprising LiF and a polymer. The anode composition of the invention has an initial coulombic efficiency of at least 90%, a cycling coulombic efficiency of at least 99%, or both.

### CROSS-REFERENCE TO RELATED APPLICATIONS

This application claims the priority benefit of U.S. Provisional Application No. 62/978,637, filed Feb. 19, 2020, which is incorporated herein by reference in its entirety.

### STATEMENT REGARDING FEDERALLY FUNDED RESEARCH

This invention was made with government support under grant number DEEE0008202 awarded by the Department of Energy. The government has certain rights in the invention.

### FIELD OF THE INVENTION

The present invention relates to an anode composition comprising (i) a core material (10) comprising a microparticle; (ii) a lithium alloy of said microparticle (14) on a surface of said core material (10); and (iii) a solid electrolyte interface (“SEI”) comprising (a) a LiF and (b) a polymer. The microparticle comprises Si, Al, Bi, Sn, Zn, or a mixture thereof. The present invention also relates to a high lithium fluoride salt concentration in a low reduction potential solvent electrolyte that is used to produce the solid electrolyte interface comprising LiF and a polymer.

### BACKGROUND OF THE INVENTION

Alloy anodes such as Si, Al, Bi etc., are the most promising anode materials for next-generation Li-ion batteries (LIBs), since they have favorable average potentials and several times higher capacities than state-of-the-art graphite anodes (3579 for Li₁₅Si₄, 993 mAh g⁻¹ for LiAl, vs. 372 mAh g⁻¹ for LiC₆). Si and Al are also the second and third-most abundant elements in the Earth's crust and are environmentally benign. Large (>10 μm) Si, Al, or Bi microparticles (SiMPs, AlMPs, or BiMPs) are especially attractive due to their low production cost and high gravimetric/volumetric capacity. However, the large volume expansion of these alloy anodes during battery operation leads to mechanical fracture and rupture of particles, inducing a loss of the inter-particle electrical contact and exposing the highly reactive freshly lithiated Si/Al/Bi surface to the electrolyte. This leads to continuous solid electrolyte interphase (SEI) growth, electrolyte consumption and pulverized Si/Al/Bi particles isolation, resulting in a low cycling Coulombic efficiency (CE) and poor cycle life. The organic-inorganic SEI formed from the reduction of commercial carbonate electrolytes can nicely tolerate the small volume change (˜12%) of graphite, enabling the micro-sized graphite anodes to achieve 1000 cycle life with an initial CE (iCE)>90% in the first cycle and cycling CE (cCE)>99.98% after 10 cycles. However, the organic-inorganic SEI is not robust enough to accommodate the SiMP, AIMP, and BiMP with a maximum volume change of ˜280%. Consequently, micro-sized SiMP/AlMP/BiMP anodes exhibit an extremely fast capacity drop to <60% of the initial value in 20 deep galvanostatic charge/discharge cycles.

Attempts to improve microsized Si alloying electrode performance by optimizing the electrode fabrication and cycling conditions have only limited success. Meanwhile, the nanoengineering has shown great promise because nano-sized Si particles (e.g., <150 nm) and Si wires (<250 nm) could resist the fracture during (de)lithiation cycles. Concepts such as one-dimensional nanowires, core-shell nanostructures, hollow particles, tubes, porous Si, silicon carbide (SiC), and SiC/MXenes composites effectively improved alloying anodes cycling stability in half cells. However, the complex fabrication and associated high cost of nanostructured Si powders make them less appealing for practical applications. Recently, functional binders with strong adhesive and elastic properties were reported to keep the pulverized micro-sized Si particles coalesced without disintegration, reducing the reaction of the pulverized Si particles with electrolytes, enabling 1-3 μm SiMPs to be stably charged/discharged in a Li/Si half-cell configuration for 150 cycles with an iCE of 91% and cCE of 99.8% after 22 cycles, and in a Si/LiNi_{0.8}Co_{0.15}Al_{0.05}O₂ full cell for 50 cycles. Another effective method to avoid an electrolyte reacting with pulverized Si is to encapsulate the 1-3 μm SiMPs with a conformal multilayered graphene cage, allowing the SiMPs to expand and fracture within the cage, while the electrolyte is blocked by a stable SEI formed on the graphene cage surface. The graphene-encapsulated SiMPs exhibit an ICE of 93.2%, increasing to 99.5% after five cycles. However, the relatively low cCE of <99.7% for Si requires a significant excess of Li to be introduced either by a costly pre-lithiation step or by use of overdosed cathodes, increasing the cost or reducing the cell energy density.

Electrodes with cCEs below 99.9% do not meet the industry requirements for electric vehicles and many portable electronics applications. To further improve the cCEs, new electrolytes and additives for enabling microsized alloying anodes have been extensively explored with limited success due to lack of the SEI design principle for alloying anodes and the complexity of the SEI formation mechanisms. Carbonate electrolytes with fluoroethylene carbonate (FEC) and/or vinylene carbonate (VC) additives currently yield the best performance for Si anodes, yet a thick, inhomogeneous and uneven organic-inorganic SEI formed on Si is still not robust enough to tolerate the large volume change of microsized Si, resulting in continuous consumption of the Li and electrolyte, and a loss of active Si. Currently, large (>10 μm) alloying anodes without costly processing for the Li ion batteries with cCE>99.9% at practical loading have not been reported.

Therefore, there is a need for alloy electrodes, in particular alloy anodes, having an improved iCE and cCE without requiring extensive labor and/or time for fabrication.

### SUMMARY OF THE INVENTION

Some aspects of the invention provide an alloy anode and a method for producing said alloy anodes based on SEI design principle discovered by the present inventors. One particular aspect of the invention provides an anode composition (100) as schematically illustrated in Scheme 1 below. The anode composition (100) comprises: (i) a core material (10) comprising a microparticle; (ii) a lithium alloy of said microparticle (14) on a surface of said core material (10); and (iii) a solid electrolyte interface (“SEI”) comprising (a) a LiF shell-layer (18) encapsulating said lithium alloy; and optionally (b) a polymeric layer (22) on top of said LiF shell-layer (18). The term “encapsulating” refers to covering at at least 90%, typically at least 95%, often at least 98%, and most often at least 99% of the surface area. The microparticle comprises Si, Al, Bi, Sn, Zn, or a combination thereof In some embodiments, the microparticle comprises Si, Al, Bi, or a combination thereof.

In one particular embodiment, an initial coulombic efficiency (ICE), i.e., within the first five, typically within the first three, and often within the first or second charge/discharge cycles, of said anode is about 85% or greater, typically at least about 90% or greater, often at least about 93% or greater, and more often at least 95% or greater. Throughout this disclosure coulombic efficiency is determined as illustrated in the Examples section or at room temperature or under a standard condition (i.e., 20° C. and 1 atm. pressure).

Still in other embodiments, a cycling coulombic efficiency (cCE) of said anode is greater than 99%, typically greater than 99.5%, and often 99.9% or greater. cCE is defined as after at least 10, typically after at least 100, often after at least 300, and most often after at least 500 cycles of charge/discharge cycles at room temperature

Yet in other embodiments, said anode retains at least about 85%, typically at least about 90%, often at least about 93%, and more often at least about 95% of initial capacity after about 100, typically after about 200, often after about 300, and more often after about 500, deep galvanostatic charge/discharge cycles.

In other embodiments, the amount of microparticle-oxide on the surface of said core material (10) is less than about 15%, typically less than about 10%, often less than about 5%, and more often less than about 2%.

Still yet in other embodiments, said core material (10) further comprises a binder, electro-conductive carbon, or a combination thereof. In some instances, said electro-conductive carbon comprises carbon black (e.g., Ketjenblack®), carbon nanotube, graphene, or a mixture thereof. In some embodiments, the amount of said microparticle in said core material (10) is at least about 30% by weight, typically at least about 40% by weight, often at least about 50% by weigh, and more often more than 50% by weight. Yet in other embodiments, the amount of said electro-conductive carbon is in the range of from about 1% by wt. to about 50% by wt, typically from about 1% by wt. to about 40% by wt, often from about 2% by wt. to about 30% by wt., and more often from about 2% by wt. to about 20% by wt. It should be appreciated that the remainder % by wt. comprises the binder such that the total adds up to 100%.

In yet other embodiments, the average particle size of said microparticle ranges from about 0.1 μm to about 1000 μm, typically from about 0.1 μm to about 500 μm, often from about 0.2 μm to about 250 μm, more often from about 0.3 μm to about 100 μm, and still more often from about 0.5 μm to about 50 μm. In one particular embodiment, the average particle size of said microparticle is greater than 10 μm.

In further embodiments, the average particle size of said electro-conductive carbon ranges from about 0.03 μm to about 10 μm.

Another aspect of the invention provides a method for producing an anode or an alloy anode composition, said method comprising: (i) producing a slurry mixture comprising microparticles, an electro-conductive carbon; and a binder, wherein said microparticles comprises Si, Al, Bi, Sn, Zn, or a combination thereof; (ii) coating said milled slurry mixture onto a metal foil to produce an electrode composition; (iii) placing said electrode composition in an organic electrolyte solution comprising a lithium salt; and (iv) subjecting said electrode composition to a charge/discharge cycle to produce an anode composition (100) described herein.

In some embodiments, said metal foil comprises copper. Still in other embodiments, said electrolyte solution comprises a lithium salt and an organic solvent. In some instances, said lithium salt comprises lithium hexafluorophosphate (LiPF₆), LiPF₃(CF₂CF₃)₃ (“LiFAP”), lithium bis(fluorosulfonyl)imide (“LiFSI”), or a mixture thereof. The amount or the concentration of lithium salt can vary depending on a variety of factors including, but not limited to, the identify of the lithium salt, the electrolyte solvent used, nature of the microparticle (e.g., Si, Al, Bi, Sn, Zn, or a mixture thereof), etc. In one particular embodiment, the concentration of lithium salt in the electrolyte is at least about 1 M, typically at least about 1.5 M, often at least about 2 M, more often at least about 2.5 M, and most often at least about 3 M.

Still in other embodiments, said organic electrolyte solution comprises a solvent that has a reduction potential of about 0.3 V or less at room temperature. In some embodiments, the organic solvent is a cyclic or an acyclic ether. Exemplary cyclic ethers include, but are not limited to, tetrahydrofuran (THF), methyl tetrahydrofuran (MTHF), and the like. Exemplary acyclic ethers include, but are not limited to, diethyl ether, methyl ethyl ether, dipropyl ether, diisopropyl ether, and the like.

Still another aspect of the invention provides a lithium-ion battery comprising: (a) a cathode; (b) an anode as described herein and (c) an organic electrolyte solution comprising a lithium salt and an organic solvent. It should be appreciated that the term “as described herein” includes a broad definition as well as any narrow definition(s) of the anode disclosed herein. In one particular embodiment, an initial coulombic efficiency (ICE) of said anode is greater than 90%. Yet in another particular embodiment, a cycling coulombic efficiency (cCE) of said anode is greater than 99%, typically 99.5% or greater, and often 99.9% or greater. Still in another particular embodiment, said anode retains at least 90% of initial capacity after 200 deep galvanostatic charge/discharge cycles. In further particular embodiment, the amount of microparticle oxide on the surface of said core material (10) is less than 10% by weight.

Yet another aspect of the invention provides a lithium-ion battery comprising: (a) a cathode; (b) an anode, wherein said anode comprises a composition comprising (i) a core material (10) comprising a microparticle, wherein said microparticle comprises Si, Al, Bi, Sn, Zn, or a combination thereof; (ii) a lithium alloy of said microparticle (14) on a surface of said core material (10); and (iii) a solid electrolyte interface (“SEI”) comprising a LiF and optionally a polymer; and (c) an organic electrolyte solution comprising a lithium salt and an organic solvent. In one embodiment, a cycling coulombic efficiency (cCE) of said anode is greater than 99.9%. Yet in another embodiment, an initial coulombic efficiency (iCE) of said anode is greater than 90%. Still in another embodiment, said anode retains at least 90% of initial capacity after 200 deep galvanostatic charge/discharge cycles. In yet another embodiment, the amount of microparticle-oxide on the surface of said core material (10) is about 10% by weight or less.

Still another aspect of the invention provides a high lithium fluoride salt concentration in a low reduction potential solvent electrolyte. In one embodiment, the concentration of the lithium salt is about 1 M or more, typically 1.5 M or more, often 2 M or more, more often 2.5 M or more, and most often 3 M or more. Suitable lithium fluoride salts are those that are disclosed herein. Yet in another embodiment, a low reduction potential solvent comprises acyclic ether, cyclic ether, or a combination thereof. Still in further embodiments, the low reduction potential solvent comprises two or more mixture of ethers, with each ether independently being a cyclic ether or an acyclic ether. In one specific embodiment, the low reduction potential solvent comprises THF and MTHF.

Yet another aspect of the invention provides a method for producing an electrode composition. The method generally includes:

providing an admixture of (i) microparticles of an electrode material and (ii) an electrolyte solution comprising an electrolyte salt comprising lithium and fluoride, and an electrolyte solvent, wherein a reduction potential of said electrolyte salt is about 0.8 V or greater and a reduction potential of said electrolyte solvent is about 0.3 V or less, and wherein a volume change in microparticles of said electrode material during a charge-discharge cycle is at least about 50%;
adding current to said admixture to form a lithium alloy coating on said electrode material, and a lithium fluoride shell encapsulated electrode material; and
optionally forming a polymeric shell encapsulating said lithium fluoride shell.

In some embodiments, the electrolyte salt comprises inorganic salts such as lithium hexafluorophosphate (LiPF₆), LiPF₃(CF₂CF₃)₃ (“LiFAP”), lithium bis(fluorosulfonyl)imide (“LiFSI”), or a mixture thereof. Still in other embodiments, said electrode material comprises Si, Bi, Al, Zn, Sn, or a mixture thereof. Yet in other embodiments, an average particle size of said electrode material microparticles ranges from about 0.1 μm to about 1,000 μm, typically from about 0.1 μm to about 500 μm, often from about 0.2 μm to about 250 μm, more often from about 0.3 μm to about 100 μm, and still more often from about 0.5 μm to about 50 μm. In one particular embodiment, the average particle size of said microparticle is greater than 10 μm. Still in yet other embodiments, the electrolyte solvent comprises ether. In one particular embodiment, the electrolyte solvent comprises tetrahydrofuran (THF), methyl tetrahydrofuran (MTHF), or a mixture thereof. When the electrolyte solvent comprises a mixture of THF and MTHF, the ratio of THF to MTHF can vary widely depending on a variety of factors such as the nature of lithium salt, electrode material, etc. In one particular embodiment, the ratio of THF to MTHF ranges from about 0.5:2 to about 2:1, typically from about 0.5:1 to about 1.5:1, and often about 1:1.

Yet still another aspect of the invention provides a composition comprising:

(i) microparticles of an electrode material, wherein a volume change of each microparticle during a charge-discharge cycle in a lithium salt electrolyte is at least about 50%;
(ii) a lithium fluoride shell encapsulating said electrode material; and
(iii) optionally a polymeric shell encapsulating said lithium fluoride shell.

In some embodiments, a volume change during a charge/discharge cycle of said lithium fluoride shell in the lithium salt electrolyte is about 20% or less typically about 10% or less, and often about 5% or less. Still in other embodiments, the electrode material comprises Si, Bi, Al, Zn, Sn, or a mixture thereof.

### BRIEF DESCRIPTION OF THE DRAWINGS

FIG. 1A is a schematic illustration of one particular embodiment of the invention for forming an electrode composition comprising LiF SEI enabled micro-sized Si anode.

FIG. 1B shows electron localized function (ELF) and work of separation (Wₛₑₚ) for the Li alloy|LiF interfaces.

FIG. 1C is a schematic illustration of one embodiment of a cycled alloy anode of the invention with an inorganic, high interfacial energy and uniform Li alloy|SEI interface.

FIG. 2 shows charge/discharge profiles of a SiMP electrode cycled in 2 M LiPF₆ mixTHF.

FIG. 3 shows (a) charge/discharge profiles and (b) cycling stability and CE of SiMP electrode cycled in 2 M LiPF₆ mixTHF. The rate is C/5 then C/2.

FIG. 4 shows cycling stability and CEs of SiMPs cycled in 2 M LiPF₆ mixTHF and 1 M LiPF₆ EC/DMC electrolytes; the rate was C/5.

FIG. 5 shows charge/discharge profiles of a SiMP electrode cycled in 1 M LiPF₆ EC/DMC.

FIG. 6 shows (a) charge/discharge profiles and (b) cycling stability and CE of SiMP electrode cycled in 2 M LiPF₆ EC/DMC. The rate was C/5.

FIG. 7 shows charge/discharge curves at different rates of Si cycled in 2 M LiPF₆ mixTHF.

FIG. 8 shows the rate performance comparison of LiPF₆ in 2.0 M mixTHF and 1.0 M in EC/DMC.

FIG. 9 shows charge/discharge curves of Si cycled in 1 M LiPF₆ EC DMC at different rates.

FIG. 10 shows charge/discharge curves of SiMP cycled in different electrolytes and at different temperatures.

FIG. 11 is electrochemical impedance spectra of Li|Si half cells in different electrolytes after different charge/discharge cycles: (a) LiPF₆ mixTHF, (b) LiPF₆ EC/DMC

FIG. 12 shows charge/discharge curves at different rates of AlMP cycled in 2.0 M LiPF₆ mixTHF and a rate performance of AlMP cycled in 2.0 M LiPF₆ mixTHF.

### DETAILED DESCRIPTION OF THE INVENTION

Conventional methods in designing rechargeable lithium battery focuses on forming a strong bond between anode or alloy anode and the SEI to inhibit or prevent the co-intercalation and decomposition of solvents within the anode and/or alloy anode layer. While such a strategy is sufficient for anode materials having a relatively small volume change (i.e., about 25% or less, typically about 20% or less, and often about 15% or less) during charge/discharge cycle, such a strategy is not suitable for anode or electrode materials that experience a large volume change during a charge/discharge cycle. For example, in alloy anode materials with a relatively high volume change (e.g., about 50% or more, typically about 75% or more, and often about 100% or more) formation of a strong bond with the SEI results in a complete failure of the SEI layer during a repeated charge/discharge cycle. When referring to a numerical value, the terms “about” and “approximately” are used interchangeably herein and refer to being within an acceptable error range for the particular value as determined by one of ordinary skill in the art. Such a value determination will depend at least in part on how the value is measured or determined, e.g., the limitations of the measurement system, i.e., the degree of precision required for a particular purpose. For example, the term “about” can mean within 1 or more than 1 standard deviation, per the practice in the art. Alternatively, the term “about” when referring to a numerical value can mean ±20%, typically ±10%, often ±5% and more often ±1% of the numerical value. In general, however, where particular values are described in the application and claims, unless otherwise stated, the term “about” means within an acceptable error range for the particular value, typically within one standard deviation.

The present inventors have discovered that the main obstacle for achieving the stable cycling of alloy anodes that experience a large volume change during charge/discharge cycles is the breaking/reforming of the SEI layer during repeated expansion/shrinkage cycles. This breaking/reforming of SEI layer in combination with the high lithiated alloy electrochemical/chemical reactivity with the electrolytes result in a very limited number of rechargeability of such lithium batteries. Strong bonding between the SEI and the alloy surface puts additional constraints on the structural evolution during lithiation/delithiation cycling by restricting the alloy slip at the alloy/SEI interface, thus the SEI suffers from a high deformation, leading to breakage of both SEI and alloy particles, and eventual formation of isolated particles covered with a thick SEI. In addition, the non-uniform, mixed, organic-inorganic SEI generates high stresses due to the non-uniform lithiation/delithiation increasing the SEI and lithiated alloy cracking.

Some aspects of the invention are based on a surprising and unexpected discovery by the present inventors that deformation of the SEI layer can be significantly reduced by forming a layer having a low affinity to the lithiated alloy electrode. In one particular embodiment, the layer having a low affinity to the lithiated alloy electrode is a LiF layer. As used herein, the term “low affinity” refers to having an interfacial energy between the layer (e.g., LiF layer) and the lithiated alloy electrode of at least about 0.10 J/m², typically at least about 0.15 J/m², often at least about 0.20 J/m², and more often greater than about 0.20 J/m². One aspect of the invention is particularly suitable for electrode materials that have or experience a relatively large volume change during charge/discharge cycle. Exemplary electrode materials that can be used in a rechargeable lithium battery that have a high volume change include, but are not limited to, Si, Bi, Al, Zn, Sn, Sb, Mg, and a combination thereof. Table below shows comparison of the theoretical specific capacity, charge density, volume change and onset potential of various anode materials.

Table showing comparison of the theoretical specific capacity, charge density, volume change and onset potential of various anode materials

| Materials | Li | C | Li₄Ti₅O₁₂ | Si | Sn | Sb | Al | Mg | Bi |
|---|---|---|---|---|---|---|---|---|---|
| Lithiated phase | Li | LiC₆ | Li₇Ti₅O₁₂ | Li_{4.4}Si | Li_{4.4}Sn | Li₃Sb | LiAl | Li₃Mg | Li₃Bi |
| Theoretical specific capacity | 3862 | 372 | 175 | 4200 | 994 | 660 | 993 | 3350 | 385 |
| (mAh g⁻¹) | | | | | | | | | |
| Theoretical charge density | 2047 | 837 | 613 | 9786 | 7246 | 4422 | 2681 | 4355 | 3765 |
| (mAh cm⁻³) | | | | | | | | | |
| Volume change (%) | 100 | 12 | 1 | 320 | 260 | 200 | 96 | 100 | 215 |
| Potential vs. Li (~V) | 0 | 0.05 | 1.6 | 0.4 | 0.6 | 0.9 | 0.3 | 0.1 | 0.8 |

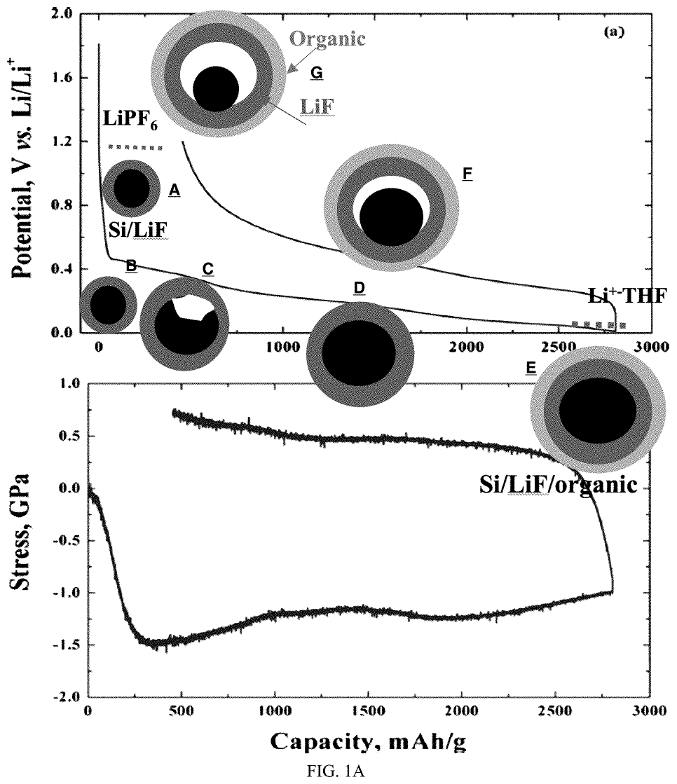

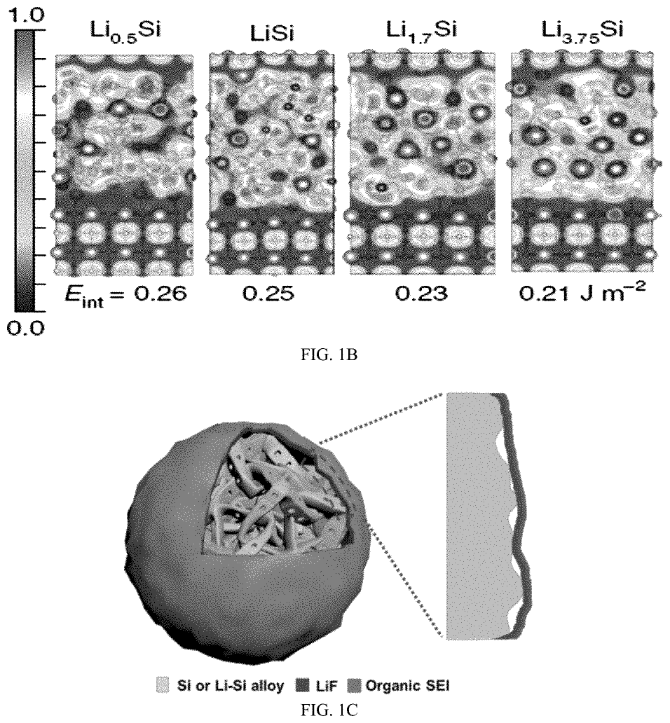

One particular aspect of the invention reduces the deformation of the SEI layer during a charge/discharge cycle by forming a layer with a low affinity to the lithiated alloy, so that the lithiated alloy can “slip” at the interface to accommodate the volume change without damaging the SEI. One particular embodiment of the present invention is schematically illustrated in FIG. 1B. As shown in FIG. 1B, microparticles of Si is placed in LiPF₆/mixTHF electrolyte and current is allowed to flow through current collector. During an initial lithiation, LiPF₆ is reduced to LiF and encapsulates Si as illustrated by “A”. The black circle in the middle represents Si having Li—Si alloy surface and the dark gray circle represents LiF shell that encapsulates Li—Si alloy. As further lithiation, the Li—Si alloy increases in volume (see, C and D). By using a solvent having a reduction potential of about 0.3 V or less, the organic layer of SEI (i.e., polymer or a polymeric layer) forms (lighter gray circle) only after Si—Li is fully expended. It should be appreciated that by stopping the lithiation or charging process prior to forming the organic layer of SEI, one can obtain a composition without the polymeric layer. During discharge, Li—Si alloy decrease in volume as it loses Li (as represented by F and G). Lithium fluoride (LiF) possesses the highest interfacial energy with a Li₄SiO₄ (fully lithiated surface oxide) and LiₓSi surface at various lithiation degrees (FIG. 1A), suggesting that Li₄SiO₄ and LiₓSi can slip easily without damaging the LiF SEI shell as the lithiated Si volume changes.

Based on a surprising and unexpected discovery by the present inventors, one particular aspect of the invention provides a composition comprising:

(i) microparticles of an electrode material, wherein a volume change of each microparticle during a charge-discharge cycle in a lithium salt electrolyte is at least about 50%;
(ii) a lithium fluoride shell encapsulating said electrode material; and
(iii) optionally a polymeric shell encapsulating said lithium fluoride shell.

In one particular embodiment, the volume change during a charge/discharge cycle of said lithium fluoride shell in the lithium salt electrolyte is about 25% or less. In another embodiment, the electrode material comprises Si, Bi, Al, Zn, Sn, or a mixture thereof. However, it should be appreciated that the scope of the invention is not limited to these particular electrode materials. In fact, any electrode material that undergoes volume change of at least about 50%, typically at least about 75%, and often at least about 100% during charge/discharge cycle can be used.

Another aspect of the invention provides a method for producing an electrode composition, said method comprising:

providing an admixture of (i) microparticles of an electrode material and (ii) an electrolyte solution comprising an electrolyte salt comprising lithium and fluoride, and an electrolyte solvent, wherein a reduction potential of said electrolyte salt is about 0.8 V or greater, typically about 1.0 V or greater, and often greater than about 1.1 V, and a reduction potential of said electrolyte solvent is about 0.3 V or less, and wherein a volume change in microparticles of said electrode material during a charge-discharge cycle is at least about 50%;
adding current to said admixture to form a lithium alloy coating on said electrode material, and a lithium fluoride shell encapsulated electrode material; and
optionally forming a polymeric shell encapsulating said lithium fluoride shell.

In some embodiments, said electrolyte salt comprises lithium and a fluoride source. Exemplary electrolyte salts comprising lithium and a fluoride source include, but are not limited to, lithium hexafluorophosphate (LiPF₆), LiPF₃(CF₂CF₃)₃ (“LiFAP”), lithium bis(fluorosulfonyl)imide (“LiFSI”), and a mixture thereof. However, it should be appreciated that the scope of the invention is not limited to a salt comprising lithium and fluoride. Any salt that can form an encapsulating shell around the alloy anode material with a weak affinity to the alloy anode material can be used.

Yet in one particular embodiment, said electrode material comprises Si, Bi, Al, Zn, Sn, or a mixture thereof.

The present invention will now be described in more detail with regard to producing SiMP, AlMP, and BiMP anodes, which assist in illustrating various features of the invention. In this regard, the present invention generally relates to anodes and methods for producing the same that overcome various limitation described above. That is, the invention relates at least in part to overcoming problems associated with anodes that may be subject to (i) a relatively large volume change during charging/discharging cycles, (ii) continuous solid electrolyte interphase growth, (iii) electrolyte consumption, (iv) pulverized anode particle isolation, (v) a low cycling coulombic efficiency, and/or (vi) poor cycle life. However, it should be appreciated that the scope of the invention is not limited to anodes comprising Si, Al, or Bi microparticles. In fact, anodes of the invention can include microparticles of Si, Al, Bi, Sn, Zn, or a combination thereof.

One particular embodiment of anodes of the invention is schematically illustrated in Scheme 1 above. It should be appreciated that this schematic illustration is provided solely for the purpose of illustrating the practice of the present invention and does not constitute limitations on the scope thereof.

Without being bound by any theory, it is believed that the anode of the present invention comprises a LiF SEI with low adhesion to lithiated alloy surface. The presence of this LiF within SEI is believed to provide heretofore unparalleled protection of core material (10) comprising microparticles that may be subject to a large volume changes during charging/discharging cycles. Some of the exemplary microparticles used in anodes of the invention include, Si, Al, Bi, Sn, Zn, and a combination thereof. In one particular embodiment, the anodes of the invention comprise microparticles of Si, Al, Bi, or a combination thereof. Still in another embodiment, the anodes of the invention comprise Si microparticles (“SiMPs”). Methods of the invention have been used to produce anodes with different specific capacity and alloying mechanism, such as, but not limited to, Si (amorphous-amorphous, except the initial lithiation process which is crystal—amorphous alloy transition), Al (crystal metal-crystal alloy), and Bi (crystal metal-crystal alloy I-crystal alloy II) anodes.

Other aspects of the invention provide methods for rationally designing electrolytes to form a thin, uniform, inorganic SEI with high interface energy (less adhesion) to these lithiated alloy. One particular embodiment of methods of the invention utilizes 2 M LiPF₆ in 1:1 v/v mixture of tetrahydrofuran (THF) and 2-methyl tetrahydrofuran (MTHF) electrolyte to form LiF SEI with low adhesion to a lithiated alloy surface enabling the Si/Al/Bi MPs (>10 μm in size) to provide 2800/970/380 mAh g⁻¹ with a long cycling life of >200, high iCE of >90% and cCE of >99.9% for large (>10 μm) Si/Al/Bi MP anodes (without any pre-treatment), in sharp contrast to the previous values of a cycle life of ˜20, iCE of ˜80% and cCE of <97% in conventional carbonate electrolytes. This finding opens new avenues for the practical application of Si/Al/Bi MP anodes.

In lithium-based batteries, the solid—electrolyte interphase (SEI) is a layer of material that forms between the negative electrode and the liquid electrolyte. SEI is produced by the breakdown of electrolyte compounds at the highly reducing potentials inherent to these systems. The SEI is one of the most important factors controlling the efficiency, safety, and lifetime of lithium batteries, and many empirical approaches have been developed to control the SEI's properties.

Traditional SEI design has focused on graphite anodes, with one of the main considerations being inhibiting the co-intercalation and decomposition of solvents inside the graphite layers. The SEI formed on graphite from an ethylene carbonate (EC)-based electrolyte features an organic-inorganic mixed structure that has a strong bond with graphite to withstand the ˜12% volume expansion upon full lithiation. However, the much higher volume changes of alloy anodes vs. graphite result in the complete failure of the organic-inorganic SEI formed from reduction of EC-based electrolytes on the alloy anode, as presented by the extremely low cCE of only <97%, thus calling for a paradigm change in the electrolyte design approach.

Without being bound by any theory, it is believed the main obstacle for achieving the stable cycling of alloy anodes is the breaking/reforming of the SEI layer during repeated expansion/shrinkage cycles, combined with the high lithiated alloy electrochemical/chemical reactivity with the electrolytes. It is believed that strong bonding between the organic-rich SEI and the alloy surface puts additional constraints on the structural evolution during lithiation/delithiation cycling by restricting the alloy slip at the alloy|SEI interface, thus the SEI suffers from a high deformation, leading to breakage of both SEI and alloy particles, and eventual formation of isolated particles covered with a thick SEI. In addition, it is believed that the non-uniform, mixed, organic-inorganic SEI also generates high stresses due to the non-uniform lithiation/delithiation, enhancing the SEI and lithiated alloy cracking. The electrolyte decomposes in these freshly formed cracks, forming SEI that eventually isolates the lithiated alloy particles.

To overcome these problems, the present inventors have discovered methods to reduce the deformation of the SEI layer by forming an SEI layer with a low affinity to the lithiated alloy. Low alloy affinity of SEI layer allows the lithiated alloy to slip at the interface to accommodate the volume change.

One particular embodiment of the invention is illustrated herein in reference to using Si microparticles. However, as stated herein, the scope of the invention includes other microparticles such as Bi, Al, Zn, Sn, as well as a combination of different microparticles. Among the known components in the SEI, lithium fluoride (LiF) possesses the highest interfacial energy with a Li₄SiO₄ (fully lithiated surface oxide) and LiₓSi surface at various lithiation degrees, suggesting that Li₄SiO₄ and LiₓSi can slip easily without damaging the LiF SEI shell as the lithiated Si volume changes. In addition, considering its wide bandgap and high electronic blocking effect of LiF that significantly reduces the thickness of the SEI (increasing the ICE). In addition, the high shear modulus of LiF creates a robust shell that can also suppress the LiₓSi pulverization. Not surprisingly, the most successful electrolytes for SiMP cycling contain FEC, which presumably leads to a LiF-contained SEI with an low electronic conductivity, improving the CE to about 99.7% from 99.0% for conventional carbonate electrolytes. However, significant organic SEI components also form during FEC reduction in addition to LiF, thus increasing the adhesion of the SEI to the Si surface and facilitating SEI deformation and rupture during LiₓSi expansion. LiF SEI design principle is universal since LiF has high interface energy to the most of alloy anodes.

To overcome these problems, the present inventors sought a method to form LiF SEI by selecting a highly fluorinated lithium salt (e.g., LiPF₆, LiPF₃(CF₂CF₃)₃ (i.e., “LiFAP”), lithium bis(fluorosulfonyl)imide) (“LiFSI”) or a combination thereof) that reduces to LiF without organic byproducts. The lithium salt was combined with solvents that only undergo reduction at low potentials so that LiF SEI is preferentially formed from reduction of the lithium salt (e.g., LiPF₆) starting at high potentials through the lithiation process. Suitable solvents with a low reduction potentials include solvents having reduction potential of about 0.7 V (at room temperature or at standard conditions) or less, typically about 0.5 V or less, often 0.4 V or less, and more often about 0.3 V or less. Alternatively, solvents used in the methods and/or lithium batteries of the invention are ethers. Exemplary ethers that can be used as solvents include cyclic ethers, such as THF, MTHF, tetrahydropyrans (“THP”) such as 1,3- or 1,4-dioxane tetrahydropyran and a mixture thereof, and acyclic ethers, such as diethyl ether, methyl ethyl ether, diisopropyl ether, dimethoxyethane, diethylene glycol dimethyl ether, tetraethylene glycol dimethyl ether and a mixture thereof.

Again without being bound by any theory, it is believe that after the formation/adjustment of the SEI in the initial cycles, LiₓSi will be expanding/shrinking within the LiF-rich SEI. As used herein, the term “initial cycles” refers to first 50 or less, typically first 40 or less, often first 30 or less, more often first 20 or less, still more often first 10 or less, and most often first 5 or less cycles of charging/discharging. To increase the potential of the lithium salt (e.g., LiPF₆) reduction, it is important to realize that the lithium salt reduction potential depends on the extent of ionic aggregation. A greater number of Li⁺ ions bound to its counter cation (e.g., PF₆⁻) leads to the stabilization of excess electrons near the anion, making the reduction and LiF formation energetically favorable at higher potentials.

Surprisingly and unexpectedly, it was discovered by the present inventors that counterintuitive to the present understanding, using a lithium salt with a high degree of aggregation in combination with an organic solvent having a low reduction potential provided lithium batteries that have (i) stable anodes during charging/discharging cycles, (ii) a significantly reduced solid electrolyte interphase growth during charging/discharging cycles, (iii) a significantly reduced electrolyte consumption, (iv) reduced pulverization of anode particle isolation, (v) a high cycling coulombic efficiency, and/or (vi) a significantly improved cycle life.

For conventional EC:dimethyl carbonate (DMC) (1:1) carbonate electrolytes, solvent separated ion pairs (SSIPs) dominate ˜60% of the solvation structure with 38% of the ions being contact ion pairs (CIPs) and essentially no ionic aggregates (AGG). QC calculations predict that a reduction of LiPF₆ CIPs in EC/DMC solvents occurs at potentials close to reduction of EC and DMC occurring; thus, LiF is expected to segregate in the organic matrix, forming a heterogeneous, mixed organic and inorganic SEI with large separate domain. Linear and cyclic ethers have much lower thermodynamic reduction potentials than those of esters, making them good solvent candidates for supporting preferential fluorinated salt decomposition. In particular, THF, MTHF, and triethylene glycol dimethyl ether (TEGDME or “G3”) solvents have a very low reduction potential near 0.0-0.3 V. Experiments shows salt aggregation and CIP formation progressively increased in the sequence of 1 M LiPF₆ in G3<1 M LiTFSI in mixTHF (e.g., 1:1 mixture of THF and MTHF by volume) <1 M LiPF₆ in mixTHF. Importantly, a high degree of LiPF₆ aggregates (AGG) in the mixTHF-LiPF₆ electrolyte pushes the onset reduction potential of LiPF₆ above 1.1 V, which is substantially higher than the reduction potentials of THF and MTHF around 0.0-0.3 V. Thus, a highly uniform LiF SEI layer is believed to form on Si during the lithiation of alloy above 0.1 V and only minor organic components form as a result of the mixTHF solvents reduction on the LiF surface near the end of the Si lithiation in LiPF₆ mixTHF electrolyte, in sharp contrast to the mixed organic-inorganic SEI in EC/DMC. The low mixTHF solvent viscosity and poor LiF solvation in mixTHF solvents further enhance the kinetics of LiF salt aggregation after LiPF₆ reduction. These modeling predictions are in accord with the observation that monodentate THF and MTHF molecules have the lowest solvation ability with Li⁺ because of the absence of the chelating effect. It should be noted that the selection of solvent is not limited to THF and MTHF, other solvents that satisfies the above design principle of low solvation ability and high cathodic stability (or is stabilized by electrolyte structure and additives) can also be used for the electrolytes for alloy anodes of the present invention.

To further validate predictions from the MD simulation, a systematic Raman spectroscopy characterization of the esters and ethers solvation was performed. The solvation ability of monodentate THF and MTHF with typical multidentate ethers such as DME (“G1”), DEGDME (“G2”), and TEGDME (G3) were compared by acquiring the Raman spectra of 1 M of LiTFSI salt in these solvents. The solvation structure information was derived from the Raman band shift of the TFSI⁻ anion (740 cm⁻¹, expansion/contraction of the entire anion) and the CH₂ stretching mode of the solvent molecules. The TFSI⁻ anion Raman band is a known marker for TFSI⁻ . . . Li⁺ cation coordination. The Raman shift of the TFSI⁻ anion band at ˜740 cm⁻¹ were compared in various ether electrolytes. The Raman peak blueshift increased in the following order: G3≈G2<G1<THF<MTHF indicating the increasing ionic association between Li⁺ and the TFSI⁻ anion. The blueshift of the Raman solvent band were also compared upon addition of 1 M of LiTFSI, which decreased in the sequence of G3≈G2>G1>THF≈MTHF, indicating a decreasing solvent solvation. These data indicate THF and MTHF have the lowest solvation ability and stand out as solvents to support the preferential salt reduction forming LiF, while THF and MTHF themselves will be reduced at a much lower potential. In addition, the low solvation ability of solvents also improved the chemical compatibility with salt. For example, while G1 and G2 immediately polymerized once mixed with LiPF₆ salt, the 1:1 mixture of THF and MTHF was chemically stable.

Since the local Li⁺ concentration around the anions controls the salt reduction potential, the solvation structure was compared, namely, SSIPs, CIPs and AGGs in the mixTHF and carbonate-based electrolytes. The results showed that in 1 M LiPF₆ solutions, SSIPs decrease from ˜60% in carbonate to ˜8% in mixTHF, while CIPs increase from ˜38% in carbonate to 87% in mixTHF consistent with the drop of the solvent dielectric constant from ˜34 for mixed carbonates to 6.8 for mixTHF (see Table 1). A small fraction of the Li⁺PF₆⁻Li⁺ AGGs (˜5%) were observed in the 1 M LiPF₆ in mixTHF, and further increased to 10% as the LiPF₆ salt concentration increased from 1.0 to 2.0 M. A higher salt concentration has three benefits: 1) upshifts the salt decomposition potential to above 1.17V, facilitating LiF formation due to higher aggregation; 2) suppresses the solvent reduction to lower potentials, inhibiting the formation of organic components in the SEI during alloy expansion; and 3) extending the electrolyte oxidation potential to >4.2V for 2 M LiPF₆ in mixTHF electrolyte as the fraction of free solvent decreases. Anodically, this electrolyte is stable up to 4.6, 4.2, and 4.1 Von stainless steel (SS), platinum (Pt), and carbon black on graphite foil (CB on GF), respectively. And even in the worst case of CB on GF, the electrolyte passivates the electrode after the initial scan. Further extension of the ether based electrolyte anodic stability has been proved possible by adding additives.

Without being bound by any theory, it is believed that in 2 M LiPF₆ in mixTHF electrolyte, the dominant LiPF₆ reduction forms an initial LiF SEI and repairs it by LiF during alloy lithiation from the preferred LiPF₆ reduction. When the voltage goes very low at the fully lithiated alloy state, the solvent starts to decompose, providing a thin layer of organic shell outside of the LiF layer because the very low electronic conductivity of LiF limits the reduction of mixTHF solvents. It is believed that such a LiF/organic bilayer SEI, formed after the full alloy lithiation, is thin, holds the lithiated alloy together and blocks the electrolyte penetration even when Si that is contained within the LiF/organic bilayer SEI is pulverized. It allows the lithiated alloy underneath of LiF to shrink through its elastic and plastic deformation followed delithiation due to the high interfacial energy at the LiF/alloy interface, thus maintaining the integrity of alloy microparticles during expansion/shrinkage (FIG. 1C). Therefore, the LiF/organic SEI bilayer functions as a robust shell that strongly holds the ruptured/flowed alloy together rather than insolating the ruptured alloy due to the organic-dominated SEI formed in traditional electrolytes. For cathode side, although both THF and MTHF were believed to have low anodic stability, the high fraction of LiPF₆ CIPs and AGGs in 2.0 M LiPF₆ in mixTHF electrolyte enabled this electrolyte to stably cycle LiNi_{0.8}Co_{0.15}Al_{0.05}O₂ (NCA) to 4.1V, much higher than common ether-based electrolytes.

TABLE 1
Properties of pure THF, MTHF and mixTHF
solvents at 25° C. from MD simulations
and previous experiments.

| | THF | MTHF | mixTHF |
|---|---|---|---|
| Number of solvents/box | 512 | 512 | 392 (THF) |
| | | | 320 (MTHF) |
| Equilibration run (ns) | 12 | 13.3 | 12 |
| Production run (ns) | 17.7 | 12 | 16.2 |
| Box size (Å) | 41.4 | 44.16 | 47.72 |
| Density (MD) (kg m⁻³) | 864 | 850.5 | 853 |
| Density (exp.) (kg m⁻³) | 882 | 849.04 | |
| Self-diffusion coefficient | 30.8 | 25.6 | 29.9 (THF) |
| (MD) (10⁻¹⁰ m² s⁻¹) | | | 28.0 (MTHF) |
| Self-diffusion coefficient | 30 | | |
| (exp.) (10⁻¹⁰ m² s⁻¹) | | | |
| Viscosity (MD) (mPa s) | 0.42 | 0.48 | 0.45 |
| Viscosity (exp.) (mPa s) | 0.4631 | 0.4776 | |
| Dielectric constant (MD) | 8.1 | 6.2 | 6.8 |
| Dielectric constant (exp.) | 7.52 | 6.97, 6.4 | |

The commercial bulk SiMPs with a −325 mesh was used as-received without any treatment. It is >10 μm in size, as revealed by scanning electron microscope (SEM). The sharp diffraction peaks of the bulk SiMPs in the X-ray diffraction (XRD) pattern are characteristic for crystalline Si. The SiMP electrode comprises 60 wt % SiMPs, 20 wt % Ketjen Black, and 20 wt % lithium polyacrylic acid (LPAA), and was produced by hand milling and blade-coating of the slurry onto a Cu foil. The Si electrode processing was the same as that of commercial graphite electrodes without any additional pretreatment or pre-lithiation. These developed electrolytes enabled a simple drop-in replacement for current graphite anode fabrication technology, ready to be integrated in a current battery production line for commercialization.

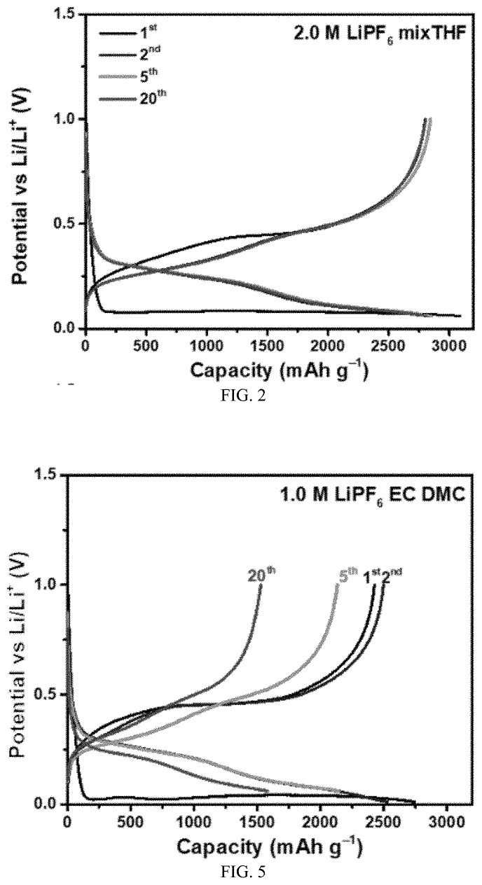

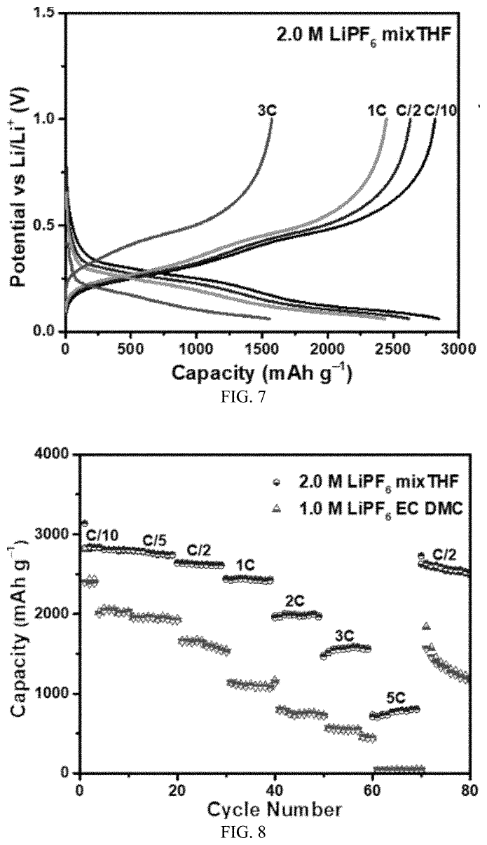

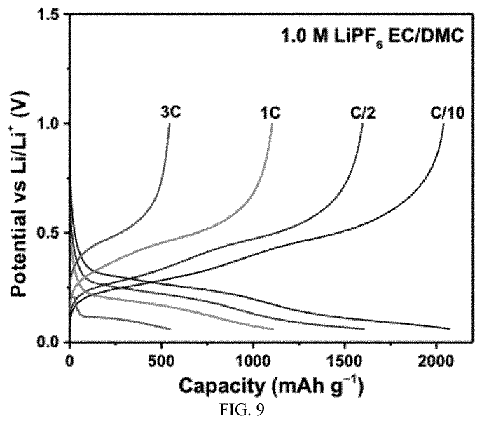

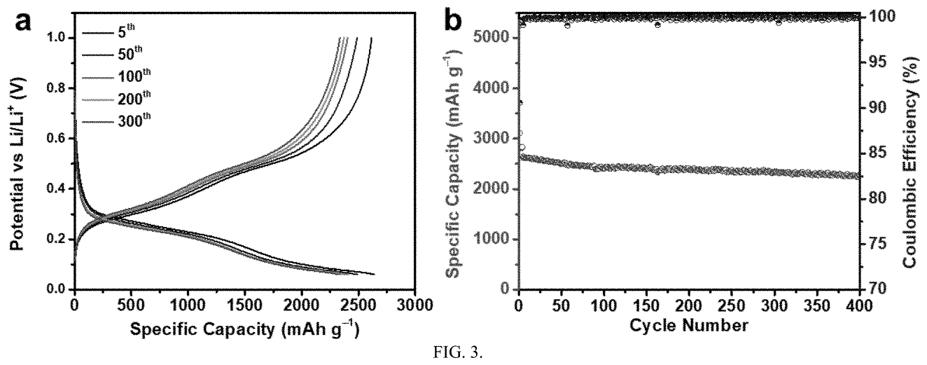

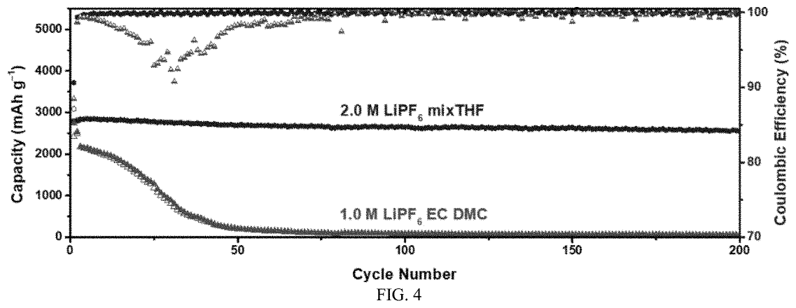

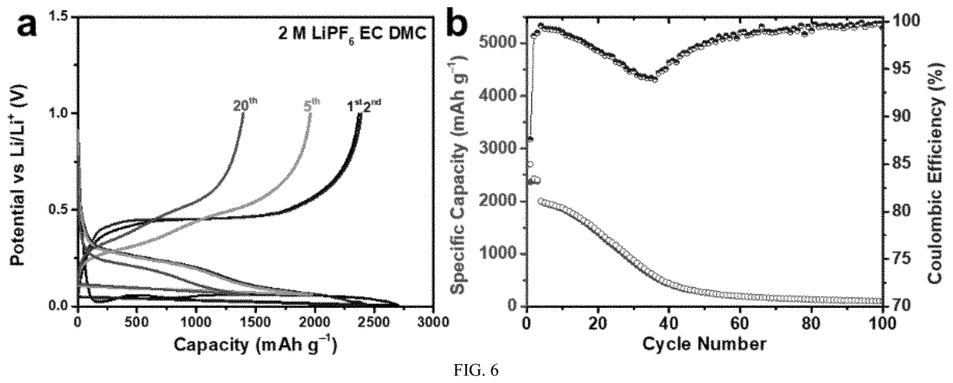

The electrochemical performance of SiMPs in 2.0 M LiPF₆ mixTHF electrolyte was evaluated by galvanostatic charge/discharge from 0.06 to 1.0 V in 2032 coin cells using Li as a counter electrode. The Si mass loading was ˜2.0 mg cm⁻² with multi layers of SiMPs, corresponding to a high areal capacity of 5.6 mAh cm⁻², which is about 2 times of the areal capacity for commercial cathodes. The reversible capacity of the SiMPs reached ˜2,800 mAh g⁻¹ at a current density of C/5 (1 C=3579 mA g⁻¹) in the 2.0 M LiPF₆ mixTHF electrolyte (FIG. 2). It is believed the achieved capacity was a little lower than the theoretical value because of the stress-induced overpotential during lithiation. The high cycling stability was demonstrated by the almost unchanged capacity during the first 20 cycles and the overlapped charge/discharge curves after the 2^{nd} cycle (FIG. 2). As shown in FIG. 3, the capacity retention was 100.0%, 96.3% and 94.4% after 20, 50 and 100 cycles, respectively. Even after 400^{th} cycle, capacity retention is still 90.0%. The high and stable specific capacity indicates that SiMPs are fully utilized and remain electrically well connected during repeated electrochemical lithiation/delithiation. The CE of >10 μm SiMPs reaches 90.6% in the first cycle and jumps to >99.9% at the 7^{th} cycle and remains >99.9% in the following cycles (FIGS. 3 and 4), which is higher than the CE of small SiMPs (1-3 μm) confined by a graphene cage or using an elastic binder. In sharp contrast, for the Si electrodes cycled in conventional 1 M LiPF₆ EC/DMC electrolyte, ˜40% of the capacity was lost within 20 cycles (FIG. 5), and only ˜8% of the capacity maintained after 50 cycles. CEs were as low as 96-97% in the first several cycles and only hover around 98.0% after the 50^{th} cycle with a low specific capacity of 200 mAh g⁻¹, which is consistent with previous reports. Increasing salt concentration to 2.0 M LiPF₆ in EC/DMC electrolyte did not improve cycling stability (FIG. 6) and even decreased the specific capacity due to increased electrolyte viscosity.

In addition to the dramatic cycling stability improvement, it was found that the rate capability of the Si electrode at a high areal capacity of 5.6 mAh cm⁻² in LiPF₆ mixTHF electrolyte also far exceeded that in standard 1 M LiPF₆ EC/DMC electrolyte. As shown in FIGS. 7 and 8, at a discharge rate of 1 C (3.58 A g⁻¹), the Si electrode in 2 M LiPF₆ mixTHF can retain over 2400 mAh g ^{t},corresponding to over 87% of the capacity at 0.1 C; while only 1098 mAh g⁻¹, 54% with respect to 0.1 C, is achieved in standard 1 M LiPF₆ EC/DMC electrolyte (FIG. 9). Even at an extremely high current density of 3 C (10.7 A g⁻¹), the Si electrode in 2 M LiPF₆ mixTHF still maintained a capacity of 1,580 mA h g⁻¹, nearly three times of that (539 mA h g⁻¹) in 1 M LiPF₆ EC/DMC electrolyte. The excellent rate performance was also verified on a pure Si film (no carbon black or binder) by cyclic voltammetry (CV) tests. At a low scan rate of 2 mV s⁻, the Si film electrodes in both electrolytes showed peaks related to lithiation/delithiation of Si, with clearly separated into two peaks in LiPF₆ mixTHF electrolyte but merged into a single peak in LiPF₆ EC/DMC electrolyte due to slow reaction kinetics. The difference was more distinct at a high scan rate of 10 mV s⁻¹, in which the LiPF₆ mixTHF electrolyte can still support Si-alloying reactions, while no peaks related to the Li—Si reaction are observed in the LiPF₆ EC/DMC electrolyte. Without interference from conductive carbon and a binder, the rate capability difference is attributed to the low SEI resistance in the LiPF₆ mixTHF electrolyte.

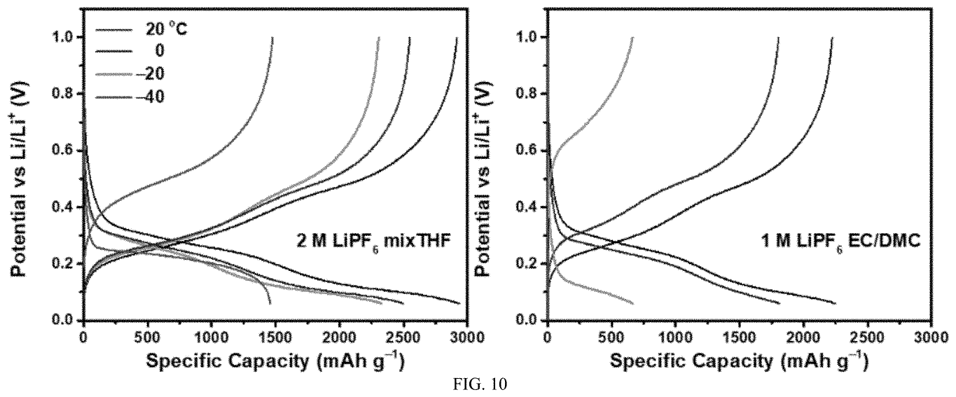

Surprisingly and unexpectedly, unlike SiMPs cycled in carbonates, SiMPs also showed an outstanding low temperature performance in 2.0 M LiPF₆ mixTHF electrolyte (FIG. 10). As the temperature decreases from 20 to 0° C., −20 and −40° C., the SiMP electrodes in LiPF₆ mixTHF electrolyte achieve reversible capacities of 2922, 2547, 2304 and 1475 mAh respectively, while only 2221, 1802, 658 and 0 mAh g⁻¹ were reached for SiMP in 1.0 M LiPF₆ EC/DMC electrolyte at the same temperatures. The capacity value at −40° C. in 2.0 M LiPF₆ mixTHF is 224% that of the capacity at −20° C. in 1.0 M LiPF₆ EC/DMC, demonstrating the outstanding performance at low temperatures. The super low-temperature performance of Si at −40° C. is unique to 2.0 M LiPF₆ mixTHF electrolyte.

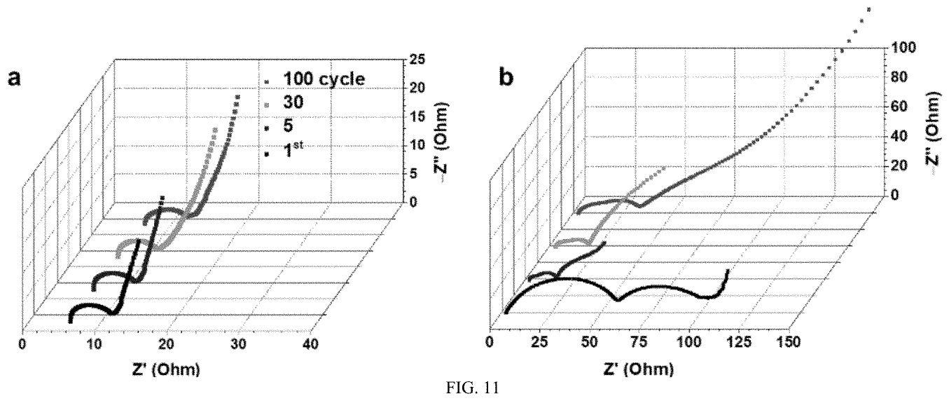

The advantages in cycling, rate and low-temperature performances in 2.0 M LiPF₆ mixTHF electrolyte are attributed to the thin and, importantly, very stable SEI, as evidenced by the small and almost-constant R_{SEI} during cycling from impedance spectra collected at the fully lithiated state (FIG. 11). The stable R_{SEI} demonstrates that the SEI is robust and maintains good integrity with SiMPs upon cycling. Such anode performance at room and very low temperatures of Si particles with a large size of >10 μm in LIBs is unprecedented. On the contrary, the R_{SEI} in 1.0 M LiPF₆ EC/DMC electrolyte first decreases from the 1^{st} to 5^{th} cycle as SiMP particles fracture and increase the surface area (FIG. 11), followed by an impedance increase due to the continuous growth and thickening of the SEI on the electrode. All the cycling performance, rate capability, CE and low-temperature behaviors achieved in 2.0 M LiPF₆ mixTHF are the best reported for SiMPs. This unique solvation structure as well as the stable LiF/organic bilayer SEI developed in 2.0 M LiPF₆ mixTHF electrolyte enable the highly stable cycling of the large (>10 μm) SiMPs, and most importantly, substantially improve the cCE to >99.9%. Since all the electrode configurations are the same, the distinct electrochemical difference of the Si electrode in the above electrolytes is believed to be mainly attributed to the property of their corresponding SEI layers.

It should be noted that the electrolyte design principle and the resulting a relatively high lithium fluoride salt concentration in a low reduction potential solvent (e.g., 2.0 M LiPF₆ mixTHF) electrolytes are universal for the alloy anodes. Applicability of this high lithium fluoride salt concentration in a low reduction potential solvent electrolyte (e.g., 2.0 M LiPF₆ mixTHF electrolyte) was validated using AlMP and BiMP. Different from the sloping charge/discharge curves for the SiMP, the AlMP showed an especially flat lithation/delithiation plateau centered at 0.4 V, implying a first-order phase transition process. The thermodynamic potential hysteresis was only about 0.04 V in the phase transition region. The AlMP with the discharge/charge voltage plateau of 0.4 V vs. Li/Li⁺, practically an ideal operating voltage, can fill the gap between the present 0.1 V graphite and the 1.5 V Li₄Ti₅O₁₂ (LTO) anodes, but delivers a reversible capacity 2.5 times higher than graphite, and 5 times higher than LTO. Ex-situ XRD showed that the crystalline Al and AlLi phase transitions without any other phases take place in the charge/discharge process, in line with the ideal flat charge/discharge profiles. The absence of Al/LiAl peaks in fully lithiated/delithiated state, respectively, indicates the full conversion of all the active material in the charge/discharge cycles.

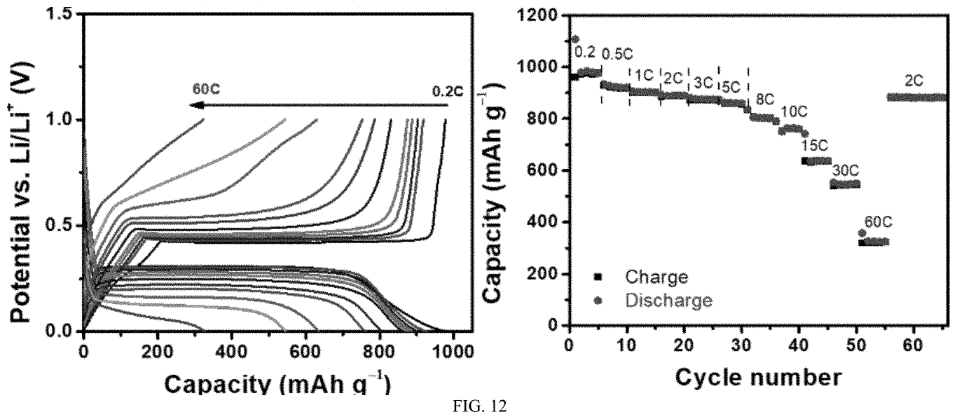

The AlMP electrode in LiPF₆ mixTHF electrolyte demonstrates a significantly improved rate capability (FIG. 12). At a 30 C charge/discharge current (2 min to total charge/discharge), more than 50% capacity can still be achieved. Such high rate capability has never been reported for any microsized alloying Li-ion anodes. When the current rate is finally returned to 2 C, a capacity of ˜900 mAh g⁻¹ was recovered, indicating the excellent tolerance of the rapid phase transitions between the Al and AlLi. Comparison of the long cycling performance of the AlMP in 2.0 M LiPF₆ mixTHF and in conventional 1.0 M LiPF₆ EC/DMC electrolytes showed the capacity of AlMP decayed to less than 10% of its initial capacity with a cycling CE of only ˜85% in the first 20 cycles in the 1.0 M LiPF₆ EC/DMC electrolyte. In sharp contrast, no capacity decay was observed for the AlMP in the 2.0 M LiPF₆ mixTHF electrolyte for over 260 cycles. CE of AlMPs reached 91.6% in the initial cycle and jumped to >99.9% at the 8th cycle and remained >99.9% in the following cycles, which is much higher than the CE of nano-Al confined by a TiO₂ cage, and even comparable to the commercial MCMB anodes. The stability difference can be attributed to the repeated breakage and growth of SEI in 1.0 M LiPF₆ EC/DMC electrolyte, as indicated by the significant increased hysteresis.

The high lithium fluoride salt concentration in a low reduction potential solvent electrolyte of the invention also yields/renders a highly improved electrochemical performance for the BiMP (10-50 μm), even though two-step crystalline phase transitions (Bi+3Li⇄BiLi+2Li⇄BiLi₃), both of which follow first-order reaction mechanism, exist for the BiMP anode. At a 60 C charge/discharge current, 50% capacity was retained for the BiMP, and no any capacity decay for over 250 cycles (380 mAh g⁻¹) with a high cycling CE of >99.9% was detected for the BiMP in LiPF₆ mixTHF electrolyte.

The SEI-enabled unprecedented performance of the alloy anodes in high lithium fluoride salt concentration in a low reduction potential solvent electrolytes merit an in-depth examination of the SEI morphology and chemical composition. The latter is examined via X-ray photoelectron spectroscopy (XPS) with Ar⁺ sputtering depth profiling. Si was sputtered on a Cu foil as a working electrode to exclude the elemental interference of conductive carbon and binder, and enabled monitoring of the thickness depth-dependent SEI information. Experimentally, the half cells were disassembled in the delithiated state after 50 lithiation-delithiation cycles to examine the SEI on the Si surface. Samples were transferred into the XPS chamber under Ar protection to avoid any contamination by air.

First, the composition of SEI on Si formed in high lithium fluoride salt concentration in a low reduction potential solvent (e.g., 2.0 M LiPF₆ mixTHF) electrolyte was analyzed. The top surface of the SEI consists of both organic (RCH₂OLi) and inorganic (Li₂O, LiF) components. However, the inner part of the SEI film is more important for cycling stability of the Si electrode. XPS elemental analysis after different Ar⁺ sputtering times showed that the content of carbon, which is indicative of organic decomposition products, decreased with the increasing sputtering time to less than 10% only after 120 s. Specifically, in Si spectra, Li₄SiO₄, Si and Li—Si alloy dominated the Si spectra, with the Li—Si alloy signal reaching about ˜50% of all Si signals at 600 s of sputtering, which is assumed as the interface between the SEI and Si. The C is signal dropped to the noise level after 600 s of sputtering, accompanied by a decrease in the carbon-related O—C═O signal in the 0 is spectra. Meanwhile, the LiF signal was still strong at the interface of the SEI|Si and persisted throughout the whole sputtering process of 1500 s, indicating that inorganic ceramics without any organic reduction species were on the surface Si film, consistent with the LiF/organic bilayer SEI structure in FIG. 1C, although minor LiF products also exist in the organic outlayer of the SEI. The existence of crystalline LiF in SEI was also verified by electron diffraction patterns obtained during CryoTEM experiments. In addition, the signals of Li₄SiO₄ in both the O 1 s and Si 2p spectra reached their maximum at the SEI|Si interface (600 s of sputtering). The absence of a SiOₓ peak for Si cycled in a high lithium fluoride salt concentration in a low reduction potential solvent electrolyte further confirmed a substantially complete and homogeneous lithiation of the surface oxide layer due to a relatively uniform SEI. This Li₄SiO₄ layer on the Li—Si alloy is also beneficial to the integrity of the Si electrode because it has been demonstrated to be elastic and prevents the electrode from pulverization.

In sharp contrast, the top surface of the SEI formed in 1.0 M LiPF₆ EC/DMC electrolyte consists of both organic reduction products (lithium alkyl carbonates; RCH₂OCO₂Li) and inorganic products (LiF). The carbon and LiF signals persisted, while no Si and LiₓSi peaks appeared in whole 1500 s of sputtering, indicating the SEI was made up of mixed organic/inorganic compounds from the surface to the inner part, and the SEI layer was much thicker compared with those generated in a high lithium fluoride salt concentration in a low reduction potential solvent electrolyte of the present invention. The LiF signal intensities in the F 1 s spectra in 1.0 M LiPF₆ EC/DMC electrolyte were lower compared with those collected from the SEI in LiPF₆ mixTHF (before 600 s of sputtering), indicating less LiF was generated in LiPF₆ EC/DMC electrolyte despite the overall SEI thickness. This can be anticipated because carbonates are prone to reduction at a higher reduction potential, and thus, contribute more to the SEI compared to glymes. In addition, the O 1 s spectra of SEI formed in 1.0 M LiPF₆ EC/DMC also exhibited less Li₂O content, indicating insufficient lithiation of the surface oxide layer on SiMPs. Moreover, in the Si 2p spectra, the original SiOₓ peak (104 eV) emerged after sputtering for 300 s in the case of carbonate electrolyte, but never in a high lithium fluoride salt concentration in a low reduction potential solvent electrolyte. This remaining SiOₓ indicates incomplete lithiation of the surface oxide, and leads to higher inhomogeneity and resistance to Li⁺ diffusion, and consequently, low kinetics. The non-uniform lithiation due to a non-uniform organic-inorganic SEI also induces a high stress and strain at places where expansion is highly inhomogeneous, which easily breaks the weak, mixed organic-inorganic SEI. Consequently, repeated breaking/reforming of SEI leads to a low CE and poor stability.

The elemental composition of the bilayer SEI was also verified by CryoTEM with EDX line scans. Si sputtered on Cu was also used as the electrode to eliminate the interference of carbon and oxygen signals from the conductive carbon and binder. From the line scans, it was clearly seen that the content of F increased before the increase of Si and O, while other elements remain constantly low for Si cycled in a high lithium fluoride salt concentration in a low reduction potential solvent electrolyte, indicating the LiF layer is coated on the Si surface (with SiOₓ on Si surface), which is consistent with the XPS results. For Si cycled in 1.0 M LiPF₆ EC/DMC electrolyte, C and O increased before the increase of Si, indicating the organic components dominate the SEI in this case, which also confirms the results from XPS analysis. Additionally, EDS elemental mapping from cryoTEM also indicated the F-rich nature of the SEI generated from a high lithium fluoride salt concentration in a low reduction potential solvent electrolyte of the invention (e.g., 2.0 M LiPF₆ mixTHF electrolyte).

To further confirm the existence of the LiF SEI, electron energy loss spectroscopy (EELS) spectral imaging was performed. Lithium compounds that are commonly found in the SEI layer of LIBs have rather different valence plasmon energy and peak width. Hence, plasmon signals were used to successfully differentiate them, with the advantage that severe damage by the electron beam can be avoided at room temperature. Using this approach, spectral imaging in the plasmon energy range for both Si particles that were cycled in 2.0 M LiPF₆ mixTHF and commercial 1.0 M LiPF₆ EC/DMC electrolytes were performed and the composition at each pixel was analyzed. A hollow region in the middle of each spectral image is caused by electron mean free path limitations, and trace Li is transformed from LiF upon beam irradiation. For Si cycled in 2.0 M LiPF₆ mixTHF electrolyte, a thin layer of LiF covering most of its surfaces was found. The composition near the surfaces of Si particles from LiPF₆ mixTHF electrolyte varied significantly within small depth. Relatively sharp valence plasmon peak from LiF at ˜25eV was clearly visible on the outlayer. Underneath LiF layer, LiₓSiO_{y} sublayer and LiₓSi were observed, indicating the layered LiF|LiₓSiO_{y}|LiₓSi structure, which matched the chemical information obtained by XPS depth profiling. For Si cycled in commercial 1.0 M LiPF₆ EC/DMC electrolytes, a mixed organic/inorganic SEI with a broad peak centered around 22 eV was found for almost all of the near surface spectra indicating there was no substantial amount of LiF on the surfaces.

With all the experimental evidence discussed above, it was concluded that the uniqueness of the high lithium fluoride salt concentration in a low reduction potential solvent electrolyte (e.g., 2.0 M LiPF₆ mixTHF) is the LiF/organic bilayer SEI, which is substantially different from the traditional organic-rich organic-inorganic composite SEI.

The roughness and thickness of the SEI on Si during dynamic lithiation/delithiation was studied by in-situ electrochemical atomic force microscope (EC-AFM). This technique allows the in-situ accurate measurement of the SEI without disassembly of the electrochemical cell. A crystalline Si wafer with a super smooth surface (˜0.18 nm roughness at open circuit voltage) was used to monitor the surface morphology evolution of Si during the lithiation/delithiation process. For Si cycled in 2.0 M LiPF₆ mixTHF electrolyte, the roughness increased to ˜1.78 nm at the lithiated state and reduced to ˜1.01 nm after delithiation (1 cycle), much smaller than the corresponding values from 1.0 M LiPF₆ EC/DMC electrolyte, 3.87 and 4.06 at the lithiated and delithiated states. The different roughness is consistent with the XPS Si 2p spectra that showed the surface oxide was uniformly and fully lithiated in the a high lithium fluoride salt concentration in a low reduction potential solvent (e.g., 2.0 M LiPF₆ mixTHF) electrolyte and partially lithiated with the SiOₓ remaining in the 1.0 M LiPF₆ EC/DMC electrolyte. The 4 times as much roughness in 1.0 M LiPF₆ EC/DMC electrolyte than that in 2.0 M LiPF₆ mixTHF electrolyte indicates ˜400% strain applied to the SEI layer by lithiated Si, which can break the SEI much easier. In addition, the decreased roughness during delithiation in a high lithium fluoride salt concentration in a low reduction potential solvent (e.g., 2.0 M LiPF₆ mixTHF) electrolyte reflects that the LiF/organic bilayer SEI suppresses the irregular volume expansion and holds the Si together, which cannot be achieved by the mixed organic-inorganic

SEI from 1.0 M LiPF₆ EC/DMC electrolyte (roughness increases after delithiation). Both of these characteristics of the SEI in 2.0 M LiPF₆ mixTHF electrolyte benefit stable cycling and high CE.

The two-layer thickness of the SEI in a high lithium fluoride salt concentration in a low reduction potential solvent (e.g., 2.0 M LiPF₆ mixTHF) electrolyte was further characterized by scraping off the soft and hard SEI components on Si. Two sets of tips were used to apply different forces to remove the SEI component with different mechanical properties: 1) a soft tip to remove the surface layer with a modulus only in the MPa range, which is regarded as the soft SEI and mainly consists of organic components; and 2) a hard tip designed for removing a sample with a higher modulus in the GPa range, mainly inorganic components such as Li₂O and LiF. By sequential scarping off the top layer with the soft and hard tips after the first cycle, the soft and hard parts of the SEI layer were distinguished. The thickness of the soft SEI (organic+LiF) layer generated in 2.0 M LiPF₆ mixTHF electrolyte was 2.50 nm. The thickness and roughness of the hard pure LiF SEI in 2.0 M LiPF₆ mixTHF electrolyte were 0.37 and 0.44 nm, respectively.

The high interfacial energy between the LiF SEI and lithiated Si and Li₄SiO₄ allows lithiated Si to freely expend/shrink, forming a core/shell structure in the high lithium fluoride salt concentration in a low reduction potential solvent electrolyte (e.g., 2.0 M LiPF₆ mixTHF) (FIG. 1C), which is confirmed by SEM. Since the organic outer layer and LiF inner layer in the SEI are sensitive to electron beams, selected area electron beam irradiation was applied to gradually remove the electron beam-sensitive SEI layer on SiMPs. After electron beam irradiation of the SEI for different times, the underneath Si (or lithiated Si) was gradually exposed. It is obvious that the bulk SiMPs with polyhedron shapes and rough surfaces evolved into a walnut-like integrity coated with a smooth LiF/organic bilayer SEI after 100 deep lithiation/delithiation cycles in 2.0 M LiPF₆ in mixTHF electrolyte. This is believed to be the result of repeated plastic flow of the relatively soft LiₓSi within the stiff LiF-rich SEI, which holds the Si together and limits the rupture. The lithiation of Si is known to undergo an amorphous Li—Si alloy (a-LiₓSi) route and is accompanied by an elastic softening of the as-formed a-LiₓSi. DFT calculations showed that the shear modulus of a-LiₓSi reduces to <30 GPa when the Li fraction increases to >0.2. An Si lithiation experiment also confirmed that the LiₓSi alloy undergoes plastic deformation at a stress of ˜1 GPa after the elastic stress reaches its maximum of 1.7 GPa at a low lithiation degree of 325 mAh g⁻¹ (9% of its full capacity). LiF has a much high shear modulus of ˜50 GPa and thus can withstand the elastic stress of LiₓSi and avoid the soft a-LiₓSi from penetrating into the LiF SEI. Instead, its deformation will be restricted underneath the LiF SEI layer. Compared to the inorganic LiPON-based artificial SEI, the LiF is stiffer and is expected to largely constrain the LiₓSi expansion. Any new cracks within SEI during lithiation can be quickly self-healed by the newly formed LiF (without a weak organic component), leading to the development of the walnut-like Si integrity after cycling without any pulverization with the connected Si domains well protected under the SEI. Such bend lamellar morphology of Si allows expansion in the direction perpendicular to the lamellar, which requires the creation of a relatively small new (self-healed) LiF SEI surface to accommodate LiₓSi growth during lithiation. Moreover, a stiff LiF SEI is likely to withstand stress and prevent void collapse during delithiation, making these voids available to accommodate LiₓSi expansion during the next cycle. In addition to favorable mechanical properties, the LiF SEI layer is known to possess a high ionic-to-electronic conductivity ratio, thus a thin layer is sufficient to inhibit the unwanted side electrochemical/chemical reactions between the SiMPs and the electrolyte. On the contrary, the organic components in the organic-rich SEI formed in LiPF₆ EC/DMC electrolyte have a low interfacial energy with the LiₓSi, thus strongly bonding to the LiₓSi surface and experiencing a similar degree of deformation as the lithiated Si during the volume changes, as demonstrated by the similar pulverized particle morphology before and after electron beam irradiation. In addition, the shear modulus of the organic-rich SEI is an order of magnitude lower than LiF, which is unable to withstand the large elastic stress before the plastic deformation, resulting in the pulverization of Si. The formation of the organic-rich SEI in the pulverized Si further isolates the broken Si. Consequently, in 1.0 M LiPF₆ EC/DMC electrolyte, the morphology of the Si electrode after cycling becomes pulverized to nanoparticles and covered by a thick SEI layer. Since the SiMPs in a high lithium fluoride salt concentration in a low reduction potential solvent (e.g., 2.0 M LiPF₆ mixTHF) electrolyte of the invention gradually evolve into a walnut-configuration integrity after cycling without any pulverization ensuring a high CE of >99.9%, while the Si lithiation in conventional carbonate electrolytes accompanies significant breakage and growth of the thick SEI layer resulting in the continuous pulverization of the SiMPs and a low Coulombic efficiency (<99%). This electrolyte-enabled super SiMP anode provides the opportunity to commercialize the high-volume expansion alloy anode and guides the design of next-generation, high-energy batteries.

The formation of the LiF/organic bilayer SEI is critical for achieving the stable cycling for SiMPs. To form the LiF inner SEI layer, the salts and solvents have to meet several requirements. For the salts, the reduction product of the salts should be generated at high potentials, resulting in only LiF without organic co-products. The solvent should have a low reduction potential and low solvation ability with the salt to minimize the solvent reduction, decomposition facilitating LiF precipitation and salt aggregation to increase its reduction potential. Series of experiments were conducted to verify these rules. Firstly, LiTFSI is both thermally and chemically more stable than LiPF₆, and it does not trigger the polymerization of ether solvents at all. Moreover, MD simulations confirms that the CIPS (71%) dominate the solvation structure, leading to the preferential salt reduction, similar to the case of LiPF₆ mixTHF electrolyte. However, the 1.0 M LiTFSI mixTHF electrolyte was unable to stabilize SiMPs during cycling. The capacity dropped to 70% at 20 cycles, and further to 38% and 24% after 50 and 100 cycles, while the CE stayed at 97.4% in the first 15 cycles and slightly rose to ˜98.9% after 30 cycles when the specific capacity has dropped below 1100 mAh g⁻¹.

Electrochemical impedance spectroscopy (EIS) spectra indicated the continuous increase of interphase resistance, analogous to the case of 1.0 M LiPF₆ EC/DMC electrolyte. This is because the TFSI decomposition anion mainly proceeds via breaking the S—N or S—C bonds, creating more organic compounds, as confirmed in the XPS spectra. The SEI in LiTFSI mixTHF electrolyte forms a mixed organic-inorganic SEI, which is similar to the SEI formed in LiPF₆ EC/DMC electrolyte. As for solvents, G3 has a similar thermodynamic reduction potential as THF and MTHF. LiPF₆ G3 electrolyte is also stable after storage for at least several months, but it is even worse than the 1.0 M LiPF₆ EC/DMC system in cycling stability for SiMP electrodes; the specific capacity drops to only less than 12% of the initial value in three cycles because of the formation of a highly resistant SEI. EIS spectra reveal that a severe impedance increase was observed in this case. The failure is because G3 has a relatively strong solvation ability with LiPF₆ salt. Simulation results indicate a high fraction (50%) of SSIPs in LiPF₆ G3 electrolyte, resulting in more solvent decomposition and forming a highly insulating SEI, as confirmed by XPS spectra.

The high lithium fluoride salt concentration in a low reduction potential solvent (e.g., 2.0 M LiPF₆ mixTHF) electrolyte of the invention also enables LiFePO₄ (LFP with a 2.3 mAh cm⁻² loading) and LiNi_{0.8}Co_{0.15}Al_{0.05}O₂ (NCA with a 1.6 mAh cm⁻² loading) cathodes to achieve an excellent cycling stability. LFP was chosen because of its exceptional safety features, while the NCA has a higher energy density. By coupling the LFP cathode with these microsized alloying anodes that have high CEs of >99.9%, it was possible to construct a practical Si/Al/Bi∥LFP/NCA full cells. Neither pre-cycling of the anodes or cathodes, nor pre-lithiation of these Si/Al/Bi MP anodes were performed, with all processes following the LIB industry standards. All of these full cells exhibited stable cycling and high CE (approaching 100% after the 5^{th} cycle) at practical values of current density and high areal capacity. Moreover, no increases in the overpotentials were observed in the voltage profiles for all of these full cells at various cycle numbers indicating that both the electrodes and their electrode/electrolyte interfaces remain stable during cycling. In sharp contrast, full cells of SiMP∥LFP cycled in traditional LiPF₆ EC DMC only retained 56.3% and 4.5% after 30 and 100 cycles, respectively, with an average CE of only 91.1%. Even with the addition of the state-of-the-art effective FEC additive in 1.0 M LiPF₆ EC/DMC electrolyte, the capacity retention only slightly increased to 80.8% and 6.18% after 30 and 100 cycles, with only small improvements of an average CE (93.64%). The severe capacity decay is believed to be due to the continuous SEI growth on the SiMP anode, which leads to both a low CE and increasing hysteresis. This unprecedentedly stable full-cell with large (>10 μm) micro-sized alloying anodes, which has never been achieved to cycle stably (even in half-cell configurations) with the highest cycling CE of >99.9%, demonstrates the uniqueness of the high lithium fluoride salt concentration in a low reduction potential solvent electrolyte of the present invention. The thin and effective SEI formed in our electrolyte enables us to address the most stringent issues of microsized alloying anode materials and provide novel electrolyte.

Additional objects, advantages, and novel features of this invention will become apparent to those skilled in the art upon examination of the following examples thereof, which are not intended to be limiting. In the Examples, procedures that are constructively reduced to practice are described in the present tense, and procedures that have been carried out in the laboratory are set forth in the past tense.

### EXAMPLES

### Materials and Methods

Preparation of electrodes and electrochemical measurements: For the SiMP electrodes, a slurry was first prepared by dispersing SiMPs, LiPAA binder (10 wt % aqueous solution) and Ketjen black in water with a weight ratio of 6:2:2. The slurry was casted onto a Cu foil, dried at room temperature for 24 h and further dried at 90° C. overnight under vacuum. CR2032 coin-type half-cells were assembled by sandwiching 1 piece of polyethylene separator (Celgard) and 1 piece of glass fiber between the SiMP electrodes and lithium metal foil. The following electrolytes were used for cell assembly: 1) 1.0 M LiPF₆ in 1:1 (v/v) EC/DMC; 2) 1.0 or 2.0 M LiPF₆ in 1:1 (v/v) THF/MTHF; 3) 1.0 M LiPF₆ in triglyme (G3); and 4) 1.0 M LiTFSI in 1:1 (v/v) THF/MTHF. For AlMP and BiMP electrodes, similar protocol is applied for electrode preparation.

In the galvanostatic cell tests, the current density was set at 0.2 C (1 C=theoretical capacity) in the potential range of 0.06-1.0 V vs. Li/Li⁺ using a battery cycler (Landt, China). For electrolytes other than LiPF₆ THF/MTHF, two activation cycles with a voltage cutoff of 0.005 V were performed before the cycling test. Both the specific capacities and current densities are based on the SiMP mass only.

For SEM imaging of the electrodes after cycling, the electrodes were washed with MTHF to remove any residual Li salts from the surface of the electrodes. For full-cell testing, LiFePO4 (LFP) and LiNi_{0.8}Co_{0.15}Al_{0.05}O₂ (NCA) cathodes coated on Al foil were kindly provided by Saft America Inc. The cells were charged with a cut-off voltage of 2.5-3.45 V (LFP) or 2.7-4.1 V (NCA). For the full cell configuration, to compensate the Li consumption due to the SEI/CEI formation in the first several cycles, the capacity ratio of the cathode and anode was set as 1.3.

STEM-EDX experimental method: The composition of the SEI was also explored via scanning transmission electron microscope (STEM)-EDX line scans with a Hitachi HD2700C dedicated STEM with a probe corrector operating at 200 kV. To minimize the damage of the SEI from the electron beam, a liquid nitrogen cryo-transfer holder was employed. In addition, transmission electron microscopy (TEM) sample preparation and loading were performed in an Ar-filled glove box for the whole procedure to avoid exposure to air and moisture.

STEM EELS experimental method: Electron energy loss spectroscopy (EELS) was performed using the Nion UltraSTEM 100 STEM at Rutgers University. Electrons were accelerated at 60 kV with a beam current of ˜4 pA. Both convergence and EELS collection angles were set to 30 mrad. Spectral images were taken from 800×800 nm areas using 100×100 pixels. EEL spectra were collected with a dispersion of 0.15 eV/channel and 20 ms dwell time. No changes were observed from ADF images after the spectral imaging. TEM samples used here were prepared in an Ar-filled glove box too. In order to analyze the composition at each pixel, single scatterings from 3-50 eV was extracted from each EEL spectra by Fourier log deconvolution. Percentage of each compound was then determined by multiple linear regression. Fitting was not attempted for thick areas (thickness/λ>2.5, where λ is the inelastic mean free path of 60 kV electrons in the material), which leaves a hollow region in the middle of each spectral images. A thin layer of Li metal was detected on the perimeter of LiF covered Si. We found this is due to the near surface, thinner region of LiF is more prone to electron beam damage than the bulk, thicker part. And Li metal was transformed from LiF by electron beam radiation. This observation has been confirmed by performing similar EELS mapping on reference LiF crystals.

AFM experimental method: The in-situ EC-AFM was conducted with a Dimension ICON AFM setup inside an Ar-filled glove box, where both the H₂O and O₂ levels were below 0.1 ppm—coupled with a CH Instrument 760 E potentiostat. For all the topographical mappings, a ScanAsyst fluid plus probe (Bruker AFM Probes) was used with a nominal spring constant of 0.7 N/m, composed of a silicon nitride cantilever with a sharp Si tip. This probe was also used to remove the soft SEI layer. An RTESPA-525 probe (Bruker AFM Probes) with a nominal spring constant of 200 N/m was used to remove the hard SEI layer from the substrate, which is composed of antimony-doped Si with a Si tip. The cycling was conducted against a Li metal foil in an electrochemical cell designed for Li-ion battery materials and sealed during the AFM operation.

To measure the thickness of the soft SEI layer, first the contact mode was operated with a ScanAsyst fluid plus with a contact force of 20 nN to remove the soft SEI layer in a 1.5×1.5 cm² scanning area. Higher contact forces were also applied to assure that there was no softer SEI layer to be removed. Afterward, the same probe was used to conduct peak force tapping mode for imaging the morphology in a 5×5 cm² area, including the brushed region. This topography mapping compares the height between the brushed and un-brushed regions to measure the thickness of the soft SEI layer.

For measuring the hard SEI thickness, an RTESPA-525 probe was used with a contact force of 3.0 μN to remove all the SEI layers from the Si substrate. Higher forces were also applied to make sure that there was no more SEI layer left on the substrate. (Knowing the Young's modulus of Si to be over 100 GPa, this probe was chosen, since it can only penetrate through surfaces with a maximum of 20-30 GPa)

AFM sample preparation: The substrate used for the EC-AFM measurements is polished B-doped Si (University Wafer), with a resistivity of 0.001-0.005 ohm.cm. The substrate was cut to an almost 1 cm² surface area, and the surface area was then accurately measured for a charge discharge applied current of 20 μA/cm². Then it was rinsed with water and was submerged into a freshly made Piranha solution (H₂SO₄:H₂O₂3:1) for 3-5 mins. After that, the substrate was thoroughly rinsed with an excessive amount of ultrapure deionized water (18.2 Mohm.cm) and was dried with 99.998% N₂ gas. The backside of the substrate was scratched to get to the pure Si (more conductive) part and then was conductively glued to a thin Cu foil as a conductor using Pelco conductive carbon glue. The borders of the substrate were then glued to a Teflon adaptor using Torr Seal Sealant (Varian Vacuum Technologies) and were left for more than 24 h for both the conductive glue and the sealant to cure. The substrate was then assembled into the Bruker EC cell and was kept under vacuum overnight before inserting to the glove box for the EC-AFM measurements.

Discussion on the a-LiₓSiILiF interface: First-principles calculation based on density function theory (DFT) were performed to study the a-LiₓSi/LiF interface using the Vienna Ab Initio Simulation Package (VASP) with the Projector Augmented Wave (PAW) method. The exchange-correlation energy is described by the functional of Perderw, Burke, and Ernzerhof (PBE). The energy cutoff of the electron wave function is set to be 520 eV. The geometry optimizations are performed using the conjugated gradient (CG) method, and the convergence threshold is set to be 10⁻⁵ eV in energy and 0.01 eV Å⁻¹ in force. The work of separation for the a-LiₓSi/LiF interface is defined by Wsep=(E_{a-LixSi}+E_{LiF}−E_{a-LixSi/LiF})/A, where E_{a-LixSi}, E_{LiF}, and E_{a-LixSi/LiF} are the total energy of the slab, LiF slab and a-LiₓSi/LiF interface, and A represents the total interface area. To model the slabs, a vacuum layer larger than 12 Å is applied. In the ELF, red represents covalent, yellow ionic and green metallic bonding.

In the bulk, the covalent Si—Si bonds are replaced with ionic Li—Si bonds with increasing Li concentration forming a weak bond of mixed ionic-covalent character, with a significant charge depletion of the Li atoms and a charge accumulation of the Si atoms. The formation of weaker Li—Si bonds is expected to result in a transition from brittle to ductile with increasing Li concentration, consistent with the experimental results. The interface bonding also mainly contributed by weak metallic and ionic bonds.

The work of separation for the a-LiₓSi/LiF is listed showing the corresponding concentration. As the Li concentration increases, the work of separation increases from 0.21 J/m² (a-Li₃₇₅Si/LiF interface) to 0.26 J/m² (a-_{Li0.25}Si/LiF interface). However, the work of separation is much smaller than the a-LiSi/Cu interface reported (1.55 J/m²).

Molecular Dynamics (MD) Simulation Methodology: MD simulations were performed using a many-body polarizable APPLE&P force field. Electrostatic interactions are described using permanent charges that are centered on atoms. The off-atom situated partial charges are also added on the ether oxygens in C—O—C and the N atoms of the TFSI⁻ anion in order to improve electrostatic potential description around these species. The atom-centered isotropic dipole polarizability is used represent the induced dipoles that are damped using Thole formalism with the screening parameter (a_{T}=0.4). The repulsion-dispersion interactions are modelled using a Buckingham potential. Combining rules developed in a previous work, we apply them to the Buckingham potential for cross-terms for all atom pairs with the exception of interactions with the Li⁺ cation. The TFSI⁻/Li⁺ force field parameters were taken from Suo et al., the ether/Li/TFSI⁻ parameters were taken from Alvarado et al., while THF and MTHF charges and bonded parameters were developed in this work by fitting partial charges to the electrostatic potential around molecules obtained using the Møller-Plesset perturbation theory second-order MP2 with the aug-cc-pvTz basis set.

The MD simulation package WMI-MD was used for all of the MD simulations. The Ewald summation method was used for the electrostatic interactions between the permanent charges with either permanent charges or induced dipole moments with k=6³ vectors. Followed previous work, multiple timestep integration was employed with an inner timestep of 0.5 fs (bonded interactions), a central time step of 1.5 fs for all non-bonded interactions within a truncation distance of 8.0 Å and an outer timestep of 3.0 fs for all non-bonded interactions between 7.0 Åand the non-bonded truncation distance of 14-16 Å. The reciprocal part of Ewald was calculated every 3.0 fs. A Nose-Hoover thermostat and a barostat were used to control the temperature and pressure with the associated frequencies of 10⁻² and 0.1×10⁻⁴ fs. The atomic coordinates were saved every 2 ps for post-analysis.

Initial equilibration runs of ˜6 ns were performed in an NPT ensemble to obtain the equilibrium box size that is used to the follow-up equilibration and production runs performed in the NVT ensemble. The composition of each MD simulation cell is given in Table 2 along with the length of equilibration and production runs. Rounded values of molarity were used in discussion of the MD simulation results. Ionic conductivity is extracted previously described methodology and is reported in Table 2.

TABLE 2
Composition of MD simulation cells for electrolytes simulated at 25° C., ionic
conductivity and local anion environments: solvent separated ion pairs (SSIP), contact ion pairs
(CIP) and aggregates (AGG).

| | EC:DMC/ | | mixTHF/ | mixTHF/ | |
|---|---|---|---|---|---|
| | LiPF₆ | G3/LiPF₆ | LiTFSI | LiPF₆ | mixTHF/LiPF |
| Number of | 480 (EC) | 354 | 392(THF) | 392(THF) | 392(THF) |
| solvents/box | 352 (DMC) | | 320 (MTHF) | 320 (MTHF) | 320 (MTHF) |
| Number of salt/box | 64 | 64 | 64 | 64 | 128 |
| Molarity c (M, mol L⁻¹) | 1.0 | 0.95 | 0.88 | 0.95 | 1.88 |
| Rounded c (M) | 1M | 1M | 1M | 1M | 2M |
| Equilibration run (ns) | 39 | 34.8 | 65 | 39.2 | 25 |
| Production run (ns) | 67.6 | 19 | 20 | 30.0 | 39 |
| Box size (Å) | 47.49 | 48.18 | 49.46 | 48.24 | 48.9 |
| Conductivity (mS cm⁻¹) | 13.2 | 1.3 | 5.4 | 4.3 | 4.0 |

Anion local coordination (probabilities)

| | | | | | |
|---|---|---|---|---|---|
| SSIP (0 Li⁺ near anion) | 0.60 | 0.47 | 0.28 | 0.079 | 0.06 |
| CIP (1 Li⁺ near anion) | 0.38 | 0.52 | 0.71 | 0.867 | 0.83 |
| AGG(2 Li⁺ near anion) | 0.02 | 0.01 | 0.01 | 0.055 | 0.10 |

Additional MD simulations were performed on pure THF, MTHF solvents and their mixture THF:MTHF (1:1 vol:vol) in order to validate ability of the developed force field to predict thermodynamic and transport properties as shown in Table 1. Viscosity and self-diffusion coefficients were extracted from MD simulations using Einstein relation. Self-diffusion coefficients were corrected for the finite size effects. Dielectric constants were calculated from fluctuations of the mean-squared dipole moment of the simulation box as summarized in Table 1.

QC Calculations of Electrolyte Reduction: The reduction energy (E_{red}) and free energy (G_{red}) of a complex (M) relative to the Li/Li⁺ scale is defined using the thermodynamic energy cycles and is given by Eqs. 1 and 2:

E_{red}(M)=−[ΔEₐ+ΔG⁰_{S}(M⁻)−ΔG⁰_{S}(M)]/F−1.4, (1)

G_{red}(M)=−[ΔGₐ+ΔG⁰_{S}(M⁻)−ΔG⁰_{S}(M)]/F−1.4, (2)

where ΔEₐ and ΔGₐ are the electron attachment energy at 0 K and free energy in gas-phase at 298.15 K; ΔG_{S}(M⁻) and ΔG_{S}(M) are the free energies of solvation of the reduced and initial complexes, respectively; and F is the Faraday constant. A shift factor of 1.4 accounts for the difference between the absolute potential scale and Li/Li⁺. The shift factor depends on the nature of solvent, salt and concentration, and might vary by 0.1-0.3 V due to the variation of the Li free energy of solvation in various solvents.

QC calculations were performed using g16 Gaussian software, revision b. Solvation energy is calculated using the polarized continuum model with THF parameters for the ether-containing solvates and acetone parameters with a dielectric constant of ε=20 for EC:DMC/LiPF₆ clusters. A more accurately but computationally expensive composite G4MP2 methodology is used to predict the energy and free energy of the smaller clusters, while DFT calculations using the B3LYP functional with 6-31+G(d,p) basis set are used to predict the reduction stability for the larger clusters after confirming that B3LYP/6-31+G(d,p) calculations predict the reduction energy and free energy for the smaller solvates in good agreement with the more accurate and reliable G4MP2 calculations. When reduction of the TFSI anion is coupled with its decomposition (S—N, S—C, C—F bond breaking) or P—F bond breaking in (LiPF₆)₂ B3LYP/6-31+G(d,p) DFT overestimates their reduction potential compared to G4MP2.

Discussion of chemical stability of LiPF₆ ether electrolytes: Ether solvents such as DME (G1), DEGDME (G2) and TEGDME (G3) are widely investigated as electrolyte components for LIBs. Among them, G1 and G2 are not compatible with LiPF₆ salt, because LiPF₆ will immediately trigger the polymerization of the diglyme molecules once mixed; G3 is an exception. However, a LiPF₆ G3 electrolyte cannot provide a satisfactory cycling stability for Si electrodes. It should be noticed that NaPF6 can work well in a variety of ethers, while LiPF₆ cannot. This is because of the much stronger solvation ability of the Li⁺ cation comparing with Na⁺ and/or the stronger affinity between Li⁺ and F⁻, which makes the generation of Lewis acid, PF₅, easier. Similar phenomenon has also been reported in LiFSI and NaFSI systems, in which a highly concentrated NaFSI aqueous solution shows a good electrochemical stability window, while LiFSI hydrolyzes immediately upon contact with water. To develop a successful electrolyte that could stably cycle alloy anodes, the undesirable progressive polymerization deterioration of the electrolyte need to be averted. This can be achieved by weakening the solvation between Li⁺ and the solvent by selecting appropriate solvents.

From the structural viewpoint, the solvation between Li⁺ and the solvent can be weakened by selecting solvents with a low solvation ability. Theoretically, the Li⁺ solvation competition between the solvents and anions determines the Li⁺ solvation sheath structure, which is crucial to the behavior and properties of the electrolyte. Firstly, we tried 1 M LiPF₆ THF electrolyte; this electrolyte has a much improved chemical stability than LiPF₆ in G1 or G2. However, it still becomes polymer after storage for several days. To avoid the unwanted polymerization, MTHF was introduced into the electrolyte because it is extremely hard for MTHF to polymerize even in the presence of Lewis acids like PF₅. Experimentally, we tested THF/MTHF with different volume ratios such as 3:1, 2:1 and 1:1. It was found that the LiPF₆ THF/MTHF electrolyte with a THF/MTHF ratio of 1:1 is the most chemically stable and free from polymerization, while the other two polymerized after >1 week storage.

Discussion of the electrolyte structure: To gain a better understanding of the solvation structure of the LiPF₆ mixTHF electrolyte, we compared the solvation structure of four typical electrolytes with different salt/solvent combinations using MD simulations utilized a polarizable APPLE&P force field. Salt aggregation and CIP formation progressively increased in the sequence of 1 M LiPF₆ in EC:DMC (1:1)<1 M LiPF₆ in G3<1 M LiTFSI in mixTHF<1 M LiPF₆ in mixTHF. A much stronger salt aggregation in the mixTHF electrolyte than that in the mixed carbonate electrolyte EC:DMC(1:1) is consistent with a much smaller dielectric constant for mixTHF (ε=6.8, see Table 1) than that for EC:DMC(1:1) mixture (ε≈34), which is assumed to be close to ε=33.6 reported for EC:EMC(1:1).

A non-negligible fraction of Li⁺(PF6⁻)Li⁺ AGGs was observed in 1 M LiPF₆ in mixTHF while only CIPs were observed in other electrolytes with the fraction of Li⁺(PF₆⁻)Li⁺ AGGs being <2%. Moreover, increasing the LiPF₆ salt concentration to 2 M in mixTHF further increases the fraction of local Li⁺(PF₆⁻)Li⁺ aggregates above 10%. When the electrolyte structural properties are combined with the reduction potentials of the electrolyte components, the following picture emerges: 2 M LiPF₆ in mixTHF electrolyte has the highest fraction of Li⁺(PF₆⁻)LiLi⁺ aggregates leading to the preferential salt decomposition and LiF formation before Si expansion during lithiation due to the high reduction potential of the Li⁺(PF₆⁻)Li⁺ aggregates at 1.17 V vs. Li/LiLi⁺.

Discussion of the impedance spectra of LiPF₆ G3 and LiTFSI mixTHF: For the case of the most chemically stable LiTFSI mixTHF electrolyte, the EIS spectra showed two depressed semicircles after the first discharge, and the corresponding R_{SEI} and R_{C}T slightly increase upon cycling. In the case of the LiPF₆ G3 electrolyte, the SEI resistance increases even much faster to several hundred Ohm after only 30 cycles, one order of magnitude higher than other electrolytes. This highly resistant SEI layer leads to the severe capacity decay. These EIS spectra can well explain the different cycling performances of SiMPs in different electrolytes. For the LiPF₆ mixTHF electrolyte, the SEI formed completely in the first discharge and remained almost unchanged upon cycling, indicating its tolerance of a large volume change and the effectiveness of blocking the side reactions between the SiMPs and electrolyte; the failure mode for the other three electrolytes are as followed: for LiPF₆ EC/DMC and LiTFSI mixTHF, the continuous SEI growth-induced increased impedance causes the capacity decay; for LiPF₆ G3, the formation of a highly resistant SEI film leads to rapid capacity loss.

Discussion of the SEI structure from different electrolytes: In addition to the LiPF₆ EC/DMC electrolyte, we compared the composition of the SEI formed using electrolytes with a different salt (LiTFSI in mixTHF) or different solvent (LiPF₆ in G3). For the Si electrode cycled in LiTFSI mixTHF, RCH₂OLi and LiF species exist on the surface of the SEI, similar to that of LiPF₆ mixTHF. The main differences are 1) the lower content of F (17.4 at % compared with 26.6 at %), which indicates less salt decomposition, and 2) the appearance of a C—F bond in both the C is and F is spectra, indicating the decomposition product of LiTFSI salt (C—F compound and LiF) is different from LiPF₆ (mainly LiF). Although LiPF₆ and LiTFSI form the mutual decomposition product LiF, the lower fraction of LiF formed by LiTFSI results in a less uniform and compact SEI. This causes more electrolyte penetration through the SEI and decomposition on SiMP surface, forming a thicker SEI, as revealed by the low Si and high C content after sputtering, which leads to the increasing impedance in the EIS spectra and low cycling CE (98.9%). For the LiPF₆ mixTHF electrolyte, at 0 min of sputtering, the C is spectrum is fitted well with 3 peaks at binding energies of 290.0 eV (Li₂CO₃), 286.8 eV (C—O) and 284.8 eV (C—C, C—H), while the 0 is spectrum shows corresponding peaks at 533.4 eV (O—C═O) and 530.6 eV (lithium alkoxides, RCH₂OLi). The LiOH signal (531.7 eV) can be attributed to the reaction of RCH₂OLi with moisture in the electrolyte, while Li₂CO₃ should be the result of the LiOH reaction with CO₂ in the electrolyte or during sample transfer. These results are consistent with C and O being mainly in the form of RCH₂OLi.

For the XPS spectra of the SEI formed in LiPF₆ G3, the surface (0 min of sputtering) consists of both organic reduction products (RCH₂OLi) and inorganic products (LiF, LiₓPF_{y}). The carbon content on the surface (30.24 at %) is much higher than that in the SEI from LiPF₆ mixTHF electrolyte (19.8 at %), and this trend persisted after sputtering, which indicates that the SEI contains more organic compounds in the case of LiPF₆ G3 electrolyte. Meanwhile, the F content is low (9.4 at % compared with 26.6 at % for the mixTHF electrolyte), further confirming the lower fraction of salt decomposition products than the solvent in the SEI. The more organic content in the SEI can be attributed to 1) more solvent decomposition due to the much stronger solvation ability of G3 with respect to THF or MTHF, as confirmed by Raman spectra and MD simulations; 2) in-situ polymerization of the G3 molecule induced by salt decomposition products such as PF5. It is also observed that at all sputtering times, the Si contents are very low (<1.5 at %), demonstrating that the SEI is very thick in this electrolyte. This can be anticipated because the organic components are known to be more permeable compared with inorganic counterparts, leading to continuous electrolyte decomposition. As a result, fast capacity decay and impedance increases were observed in this electrolyte.

Versatility of the electrolyte-enhanced Si nanoparticles (SiNPs) and SiMPs (1-3μm) performance: The designed LiPF₆ mixTHF electrolyte can not only support SiMPs stable cycling with high CEs, but also significantly improve the cycling stability and CEs of SiNPs. The SiNPs retained 96% capacity after 50 cycles in LiPF₆ mixTHF electrolyte, while only 53% capacity remained in LiPF₆ EC/DMC electrolyte. For CEs, SiNPs cycled in LiPF₆ mixTHF electrolyte exhibit iCE and cCE of 78.0% and 99.7%, which are much higher than 73.9% and 96.5% for LiPF₆ EC/DMC electrolyte. This low CEs in the LiPF₆ EC/DMC electrolyte is the result of incomplete passivation and continuous growth of SEI, reflected by the largely increased hysteresis after cycling compared with the stable overlapping charge/discharge curves in LiPF₆ mixTHF electrolyte. The distinct difference in performance both in SiMPs and SiNPs demonstrate the versatility of our LiPF₆ mixTHF electrolyte.

Similarly, the designed LiPF₆ mixTHF electrolyte supports the stable cycling of SiMPs with smaller sizes (1-3 μm). For CEs, iCE and cCE of 89.6% and 99.7+% have been achieved.

The foregoing discussion of the invention has been presented for purposes of illustration and description. The foregoing is not intended to limit the invention to the form or forms disclosed herein. Although the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. All references cited herein are incorporated by reference in their entirety.

1. An anode composition (100) comprising:
(i) a core material (10) comprising a microparticle, wherein said microparticle comprises Si, Al, Bi, Sn, Zn, or a combination thereof;
(ii) a lithium alloy of said microparticle (14) on a surface of said core material (10); and
(iii) a solid electrolyte interface (“SEI”) comprising:
(a) a LiF shell-layer (18) encapsulating said lithium alloy; and
(b) a polymeric layer (22) on top of said LiF shell-layer (18).

2. The anode composition of claim 1, wherein an initial coulombic efficiency (iCE) of said anode is greater than 90%.

3. The anode composition of claim 1, wherein a cycling coulombic efficiency (cCE) of said anode is greater than 99%.

4. The anode composition of claim 1, wherein said anode retains at least 90% of initial capacity after 200 deep galvanostatic charge/discharge cycles.

5. The anode composition of claim 1, wherein the amount of microparticle-oxide on the surface of said core material (10) is less than 10%.

6-9. (canceled)

10. The anode composition of claim 1, wherein the average particle size of said microparticle ranges from about 0.5 μm to about 50 μm.

11-16. (canceled)

17. A lithium-ion battery comprising:
(a) a cathode;
(b) an anode, wherein said anode comprises a composition comprising:
(i) a core material (10) comprising a metal microparticle, wherein said metal comprises Si, Al, Bi, or a combination thereof;
(ii) a lithium alloy of said metal (14) on a surface of said core material (10); and
(iii) a solid electrolyte interface (“SEI”) comprising:
(A) a LiF shell-layer (18) encapsulating said lithium alloy; and
(B) a polymeric layer (22) on top of said LiF shell-layer (18); and
(c) an organic electrolyte solution comprising a lithium salt and an organic solvent.

18. The lithium-ion battery of claim 17, wherein an initial coulombic efficiency (iCE) of said anode is greater than 90%.

19. The lithium-ion battery of claim 17, wherein a cycling coulombic efficiency (cCE) of said anode is greater than 99%.

20. The lithium-ion battery of claim 17, wherein said anode retains at least 90% of initial capacity after 200 deep galvanostatic charge/discharge cycles.

21. The lithium-ion battery of claim 17, wherein the amount of metal-oxide on the surface of said core material (10) is less than 10% by weight.

22. The lithium-ion battery of claim 17, wherein said lithium salt comprises lithium hexafluorophosphate (LiPF₆), LiPF₃(CF₂CF₃)₃ (“LiFAP”), lithium bis(fluorosulfonyl)imide (“LiFSI”), or a mixture thereof.

23. The lithium-ion battery of claim 17, wherein said organic electrolyte solution comprises a solvent that has a reduction potential of about 0.3 V or less at room temperature.

24-25. (canceled)

26. A method for producing an electrode composition, said method comprising:
providing an admixture of (i) microparticles of an electrode material and (ii) an electrolyte solution comprising an electrolyte salt comprising lithium and fluoride, and an electrolyte solvent, wherein a reduction potential of said electrolyte salt is about 0.8 V or greater and a reduction potential of said electrolyte solvent is about 0.3 V or less, and wherein a volume change in microparticles of said electrode material during a charge-discharge cycle is at least about 50%;
adding current to said admixture to form a lithium alloy coating on said electrode material, and a lithium fluoride shell encapsulated electrode material; and
optionally forming a polymeric shell encapsulating said lithium fluoride shell.

27. The method of claim 26, wherein said electrolyte salt comprises lithium hexafluorophosphate (LiPF6), LiPF3(CF2CF3)3 (“LiFAP”), lithium bis(fluorosulfonyl)imide (“LiFSI”), or a mixture thereof.

28. The method of claim 26, wherein said electrode material comprises Si, Bi, Al, Zn, Sn, or a mixture thereof.

29. The method of claim 26, wherein an average particle size of said electrode material microparticles ranges from about 0.1 μm to about 1,000 μm.

30. The method of claim 26, wherein said electrolyte solvent comprises tetrahydrofuran (THF), methyl tetrahydrofuran (MTHF), or a mixture thereof.

31. The method of claim 30, wherein said electrolyte solvent comprises a mixture of THF and MTHF.

32. The method of claim 31, wherein the ratio of THF to MTHF ranges from about 0.5:1 to about 1.5:1.

33-35. (canceled)
